(19) United States
(12) Patent Application Publication
(10) Pub. No.: US 2026/0167479 A1
(43) Pub. Date: Jun. 18, 2026

(54) SYSTEMS AND METHODS FOR DISPENSING BEVERAGES

(71) Applicant: Pani Systems, Inc., Austin, TX (US)

(72) Inventors: Allen Y. Tsai, Austin, TX (US); Charles Evan O'Neill, Austin, TX (US); Enrico Raffaele Cafaro, Danville, CA (US)

(73) Assignee: Pani Systems, Inc., Austin, TX (US)

(21) Appl. No.: 19/126,230

(22) PCT Filed: Oct. 31, 2023
(86) PCT No.: PCT/US2023/036396

§ 371 Date: Apr. 30, 2025

Related U.S. Application Data
(60) Provisional application No. 63/421,391, filed on Nov. 1, 2022.

(51) Int. Cl. B67D 1/08; A47J 31/40; A47J 31/46; B67D 1/00

(52) U.S. Cl. CPC B67D 1/0801; A47J 31/402; A47J 31/46; B67D 1/0021; B67D 1/0888; B67D 2001/0814

(57) ABSTRACT

A beverage machine and method of forming a beverage employs a pod in a pod receptacle of a beverage machine and moves one portion of the pod relative to another to open the pod and dispense beverage additive. A cap (or reservoir) of the pod may be engaged to resist movement of the cap (or reservoir) while the reservoir (or cap) is moved by a pod drive mechanism to open the pod. The pod may include an auger that functions to open and close the pod opening and/or to move beverage additive through the pod opening. The cap may include notches to engage with detents to enable the cap to be held or moved relative to the pod reservoir. A pod drive mechanism can be configured to move the cap and reservoir relative to each other, e.g., to open and close the pod and/or to dispense beverage additive.

### CROSS-REFERENCE TO RELATED APPLICATIONS

This application claims priority under 35 U.S.C. § 119(e) to U.S. Provisional Application Ser. No.: 63/421,391, filed Nov. 1, 2022, and entitled “SYSTEMS AND METHODS FOR DISPENSING BEVERAGES,” which is incorporated by reference in its entirety for all purposes.

### FIELD

Disclosed embodiments are related to systems and methods for dispensing beverages.

### BACKGROUND

Beverage machines are used to dispense or serve beverages. Some beverages are formed from one or more beverage additives before or while being dispensed from a beverage machine.

### SUMMARY

In some embodiments, a beverage dispensing system may comprise a pod receptacle. The pod receptacle may comprise a pod receiving space, a pod drive mechanism, and at least one cap retention mechanism. The pod receiving space may be sized and shaped to receive a pod, and the pod may comprise a cap and a reservoir containing a beverage additive. In some embodiments, movement of the reservoir relative to the cap may open an opening of the pod to dispense the beverage additive from the pod. In some embodiments, the pod drive mechanism may be configured to move the reservoir and open the opening of the pod. Additionally, in some embodiments, the at least one cap retention mechanism may comprise a detent configured to selectively engage the cap to resist movement of the cap in at least one direction when the reservoir is moved by the pod drive mechanism to open or close the opening of the pod. The beverage dispensing system may further comprise a liquid supply, a mixing area, and a system outlet. In some embodiments, the liquid supply may be configured to provide liquid to portions of the system. The mixing area may be configured to mix liquid from the liquid supply and beverage additive to form a beverage, and the system outlet may be fluidly coupled to the mixing area and configured to dispense the beverage.

In some embodiments, a method of forming a beverage may comprise providing a pod in a pod receptacle of a beverage machine and moving a reservoir of the pod containing a beverage additive relative to a cap of the pod with a pod drive mechanism of the beverage machine. In some embodiments, the method may comprise engaging a cap of the pod to resist movement of the cap in at least one direction while the reservoir is moved by the pod drive mechanism to open an opening of the pod and dispense beverage additive from the pod. In some embodiments, the method may further comprise mixing the beverage additive with the liquid to form a beverage and dispensing the beverage from an outlet of the beverage machine.

In some embodiments, a beverage dispensing system may comprise a pod receptacle configured to receive a pod. The pod may comprise a cap and a reservoir containing a beverage additive, and movement of the reservoir relative to the cap may selectively open or close an outlet of the pod to dispense the beverage additive from the pod. The beverage dispensing system may comprise a pod drive wheel operatively coupled to a motor. In some embodiments, the pod drive wheel may be configured to engage with an outer surface of the reservoir when the pod is disposed in the pod receptacle and to rotate the reservoir about a longitudinal axis of the pod. In some cases, a rotational axis of the pod drive wheel may be disposed at an angle relative to the longitudinal axis such that rotation of the reservoir by the pod drive wheel urges the reservoir to rotate about the longitudinal axis and to move along the longitudinal axis to selectively close or open the opening. The beverage dispensing system may further comprise a cap retaining mechanism configured to selectively prevent or allow a corresponding rotation and/or translation of the cap when the reservoir is rotated and/or translated by the pod drive wheel. The system may comprise a liquid supply, a mixing area, and a system outlet. In some embodiments, the liquid supply may be configured to provide liquid to portions of the system. The mixing area may be configured to mix liquid from the liquid supply and beverage additive to form a beverage, and the system outlet may be fluidly coupled to the mixing area and configured to dispense the beverage.

In some embodiments, a method of forming a beverage may comprise engaging a pod drive wheel of a beverage dispensing system with a beverage additive pod having a longitudinal axis. The method may further comprise dispensing a volume of a beverage additive from the beverage additive pod by rotating the pod drive wheel about a pod drive wheel axis disposed at an angle relative to the longitudinal axis of the pod to move a reservoir of the beverage additive pod away from a cap of the beverage additive pod in order to open an opening of the pod between the reservoir and the cap. The reservoir may be configured to contain the beverage additive. The method may further comprise mixing the dispensed volume of the beverage additive with a liquid received from a liquid source fluidly coupled to the system and dispensing the beverage from an outlet of the system.

In some embodiments, a pod for use in a beverage dispensing system may comprise a reservoir and a cap. The reservoir may be configured to contain a beverage additive. The cap and the reservoir may be cooperatively engaged such that relative movement of the cap and the reservoir may selectively close or open an opening of the pod to allow the beverage additive to be selectively dispensed from the pod. In some embodiments, the reservoir may include an outer surface configured to engage with a pod drive mechanism of the beverage dispensing system such that the reservoir may be movable by the pod drive mechanism in at least one longitudinal or rotational direction. In some embodiments, the cap may include a first pair of notches disposed on opposing sides of the cap and a second pair of notches disposed on opposing sides of the cap. In some embodiments, each notch may be configured to selectively engage with one or more corresponding detents of the beverage dispensing system. Each notch of the first pair may comprise a first longitudinal ridge to resist a rotation of the cap in a first rotational direction during a rotation of the reservoir in the first rotational direction. Each notch of the second pair may comprise a second circumferential ridge to resist the movement of the cap in a second longitudinal direction during the longitudinal movement of the reservoir in the second longitudinal direction, and/or a second longitudinal ridge to resist a rotation of the cap in second rotational direction opposite the first rotational direction during a rotation of the reservoir in the second rotational direction.

In some embodiments, a method of dispensing a beverage additive may comprise preventing a movement of a cap of a beverage additive pod by engaging a cap retention mechanism of a beverage machine with an engagement feature of the cap. The beverage additive pod may be configured to contain the beverage additive. The method may comprise moving a reservoir of the pod away from the cap to open an opening of the pod by actuating a pod drive mechanism of the additive dispensing system. The pod drive mechanism may be configured to engage with an outer surface of the reservoir to move the reservoir in at least one longitudinal direction and at least one rotational direction.

In some embodiments, a pod for use in a beverage dispensing system may comprise a reservoir having an internal volume configured to contain a beverage additive. The reservoir may have a proximal end portion and a distal end portion. The distal end portion may be closed and the proximal end portion may have an opening to allow the beverage additive to be dispensed from the internal volume. The pod may further include a cap comprising an auger and a shoulder. The cap may be cooperatively engaged with the opening of the reservoir, and the auger may be disposed within the opening. The auger may be configured to convey the beverage additive from the internal volume through the opening. In some embodiments, when the pod is in a closed configuration, a sealing surface of the reservoir may contact the shoulder of the auger to prevent the beverage additive from being dispensed through the opening. Additionally, when the pod is in a dispensing configuration, the sealing surface may be spaced apart from the shoulder to allow the beverage additive to be conveyed by the auger and dispensed through the opening.

In some embodiments, a method of dispensing a beverage additive may comprise opening an opening of a reservoir of a beverage additive pod by moving the reservoir away from a cap of the beverage additive pod. The method may further comprise rotating the reservoir without rotating the cap to convey the beverage additive through an auger of the cap. In some embodiments, the auger may be disposed within the opening of the reservoir and may be configured to convey the additive through the opening along a thread of the auger.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of a beverage machine according to one embodiment;

FIG. 2 is a top view of a beverage machine according to some embodiments;

FIG. 3 is a schematic illustrating a flow circuit of a beverage machine according to some embodiments;

FIG. 4 is a schematic illustrating a flow circuit of a beverage machine according to some embodiments;

FIG. 5 is a perspective view of a beverage forming module of a beverage machine;

FIG. 6 is a front perspective view of a pod receptacle of a beverage machine according to some embodiments;

FIG. 7 is a cross-sectional front view of a pod receptacle of a beverage machine;

FIG. 8 is a top view of a pod disposed within a pod receptacle according to some embodiments;

FIG. 9 is a top perspective view of portions of a pod receptacle of a beverage machine according to some embodiments;

FIG. 10A is side view of one embodiment of a pod;

FIG. 10B is a side view of the pod of FIG. 10A with a removable spacer removed;

FIG. 10C is a side view of the pod of FIG. 10B with a camming arrangement of the pod engaged;

FIG. 11A is a cross-sectional view of a pod according to some embodiments;

FIG. 11B is a cross-section view of the pod of FIG. 11A with an opening of the pod opened;

FIG. 12 is an exploded view of an interface between a cap and a reservoir of a pod, according to some embodiments;

FIG. 13 is a side view of a pod depicting various engagements with a spring pin of a pod receptacle, according to one embodiment;

FIG. 14 is a side view of a cap of a pod, according to one embodiment;

FIG. 15A is a cross-sectional view of a pod in an unused state, according to some embodiments;

FIG. 15B is a cross-sectional view of the pod of FIG. 15A in a primed state;

FIG. 16 is a side cross-sectional view of a first pod and a second pod inserted into a beverage forming module of a machine in some embodiments;

FIG. 17A is a front cross-sectional view of a pod inserted into a beverage forming module of a machine in some embodiments;

FIG. 17B is a front cross-sectional view of the pod and the beverage forming module of FIG. 17A with reclose notches of the pod engaged with spring pins of a pod receptacle;

FIG. 17C is a front cross-sectional view of the pod and the beverage forming module of FIG. 17A with the pod referenced against a lid of the beverage forming module;

FIG. 17D is a front cross-sectional view of the pod and the beverage forming module of FIG. 17A with dispense notches of the pod engaged with spring pins of the pod receptacle;

FIG. 17E is a front cross-sectional view of the pod and the beverage forming module of FIG. 17A with an opening of the pod opened;

FIG. 17F is a front cross-sectional view of the pod and the beverage forming module of FIG. 17A with the opening of the pod closed;

FIG. 18 is a graph depicting a total volume of a beverage additive dispensed as a function of a rotation of a reservoir;

FIG. 19 is a graph depicting a dispense rate of a beverage additive from a reservoir as a function of a rotation of the reservoir;

FIG. 20 is a perspective view of a pod including a cap with first and second portions that are movable relative to each other; and

FIG. 21 is a cross sectional view of the pod of FIG. 20.

### DETAILED DESCRIPTION

Beverage machines may be used to dispense or serve beverages. Some beverage machines may perform various additional functions beyond the basic dispensing function. For example, some beverage machines according to the present disclosure may filter water and/or introduce one or more beverage additives to the water to form a beverage. For example, some machines may filter dissolved solids or contaminants out of the water and introduce a re-mineralizing supplement to restore one or more minerals or nutrients that may have been removed during filtration. Other machines may introduce various other beverage additives, including flavor enhancers, nutrients, vitamins, electrolytes, or any other beverage additives.

Some beverage machines which form a beverage using one or more beverage additives may receive the beverage additives from one or more containers, which may be insertable into and/or removable from the machine. For example, some beverage machines according to the present disclosure may receive a beverage additive from a pod which may be insertable into and removable from the machine. In some examples, a pod may be sealed by a membrane which is broken or otherwise opened by a machine during use. In other examples, a pod may be sealed by a membrane which is broken or otherwise opened by a user prior to use. In some cases, the pod need not be sealed by a membrane and may be opened by moving a closure element of the pod to disengage corresponding sealing surfaces. As used herein, “seal” refers to a suitable closing to resist or prevent additive from exiting the pod, and does not necessarily require the provision of any other barrier, such as a barrier to gasses, moisture, and/or other environmental conditions. However, it will be appreciated that some seals as described herein may provide an environmental barrier in addition to the additive containment functions described.

It will be appreciated that requiring the insertion and/or removal of a pod for every use of the machine may be inconvenient for a user, and that the use and disposal of an individual pod for every use of the machine may result in significant waste. Accordingly, it may be desirable for a pod to allow for multiple uses, and for a beverage machine to accommodate multi-use pods. However, because a beverage additive may have a limited shelf life or may degrade more quickly when exposed to the ambient environment, it may be beneficial to be able to open a multi-use pod when the pod is in use and close the pod between uses.

In view of the above, the inventors have recognized and appreciated the benefits of a pod configured to be selectively opened or closed during use by a beverage machine. Such capability may maintain the freshness or extend the shelf life of the contents of the pod. In some embodiments, a pod according to the present disclosure may have an opening that can be selectively closed or opened. In some embodiments, the opening may be closed or opened by moving a first part of the pod relative to a second part of the pod. For example, a pod may have a reservoir and a cap, and a relative movement between the reservoir and a cap may selectively close or open an opening of the pod. In some cases, relative movement between a reservoir and a cap may open or close an opening or a space between the reservoir and the cap to allow a beverage additive to be dispensed from the pod or to prevent the additive from dispensing.

In some applications in which a relative movement of two or more parts of the pod may close or open an opening of the pod as described above, it may be desirable for a beverage machine to manipulate the pod and/or a part of the pod in order to open and/or close the pod to selectively dispense a beverage additive. In view of the above, the inventors have recognized and appreciated the benefits of a beverage machine including one or more pod control mechanisms capable of engaging with a pod in order to manipulate or control movement of the pod or a part of the pod. In various embodiments, a pod control mechanism may be capable of enabling, facilitating, limiting, resisting, and/or preventing a movement of a pod or a part of the pod. For example, in some embodiments, a machine may have a pod retention mechanism to prevent movement of a first part of a pod and a pod drive mechanism to move a second part of the pod relative to the first part. In some embodiments, a pod retention mechanism may include a cap retention mechanism configured to selectively engage the cap to resist movement of the cap in at least one direction when the reservoir is moved by a pod drive mechanism to open the opening of the pod. In some embodiments, a pod retention mechanism may include a reservoir retention mechanism configured to selectively engage the reservoir to resist movement of the reservoir in at least one direction when the cap is moved by a pod drive mechanism to open the opening of the pod. Some pod control mechanisms may additionally or alternatively enable or facilitate a more precise process for dispensing a beverage additive from a pod. In some embodiments, pod control mechanisms may control a relative spacing of the parts to close or open an opening of the pod. In some embodiments, a predetermined volume of the beverage additive may be dispensed in response to a predetermined movement of at least one part of the pod, e.g., relative to another part of the pod, such as rotation of a pod cap relative to a reservoir to open an outlet of the pod.

In addition to the pod control mechanisms of a machine, a pod may include one or more engagement features which enable or facilitate engagement between the pod and a pod control mechanism. In some embodiments, a pod retention mechanism may comprise a detent configured to engage with the pod to prevent a movement of the pod or a portion of the pod in at least one direction of movement. In some such embodiments, an engagement feature of a pod may comprise one or more notches or ridges configured to engage with the detent. For example, a pod retention mechanism may comprise one or more spring pins to apply a retentive spring force to a notch of a pod in order to prevent a rotation and/or a translation of the pod or a portion thereof. Additionally or alternatively, a pod drive mechanism may comprise a pod drive wheel configured to frictionally engage with the pod or a portion thereof such that a rotation of the pod drive wheel may cause a corresponding rotation and/or translation of the pod or the portion of the pod. In some embodiments, an engagement feature of the pod may comprise an outer surface of the pod configured to facilitate engagement with the pod drive wheel. For example, the outer surface may be provided with a rough surface finish, an engineered coating or covering, and/or one or more other features to enhance the frictional engagement. It will be appreciated that in some such embodiments, the pod drive wheel may additionally or alternatively be provided with a rough surface finish, an engineered coating or covering, and/or one or more other features.

In various applications, a beverage additive may be provided in either a liquid form or a solid form (e.g., a powder). Therefore, a pod may be configured to contain and dispense either a liquid or a powder. It will be appreciated that the benefits of a liquid beverage additive may include a reduced bulk for a given mass of the additive, and/or the relative ease of controlling or metering a liquid beverage additive when dispensing the additive from a pod. It will further be appreciated that the benefits of a powder beverage additive may include a reduced weight for a given bulk or volume of the additive (i.e., significantly reduced density as compared to a liquid), the ability to increase a concentration of a particular ingredient beyond what may be feasible in a liquid solution, and/or a reduced sensitivity to storage conditions (e.g., a liquid may require refrigeration and/or preservatives).

In view of the above, the inventors have recognized and appreciated the benefits of a pod which allows for precise dispensing of a powder beverage additive from the pod. Such embodiments or configurations may realize the benefits of precisely controlled dispensing that may be typically associated with liquid additives, without sacrificing the benefits of powder beverage additives (e.g., reduced weight and reduced sensitivity to storage conditions). In some embodiments, the pod may include an auger configured to guide or convey the beverage additive from a reservoir of the pod through an opening of the pod. In some such embodiments, a reservoir of the pod may be configured to rotate relative to the auger, such that rotation of the reservoir may convey the beverage additive via a thread of the auger. In some embodiments, rotation of the reservoir by a predetermined degree of rotation relative to the auger may result in a predetermined volume of the beverage additive being dispensed. Additionally or alternatively, rotation of the reservoir relative to the auger for a predetermined time may result in a predetermined volume of the beverage additive being dispensed.

In some embodiments, a beverage additive pod or a beverage machine may be formed from any appropriate materials, including any appropriate plastic or metallic material. In some embodiments, a pod or a machine may be formed from recyclable materials, including one or more recyclable plastics and/or one or more recyclable metals. For example, a pod or a machine may be formed from polyethylene terephthalate (PET), high-density polyethylene (HDPE), low-density polyethylene (LDPE), vinyl, polyvinyl chloride (PVC), polypropylene, polystyrene, acrylonitrile butadiene styrene (ABS), aluminum, steel, tin, nickel, or any other appropriate material, including any appropriate combination of the foregoing and, in the case of metallic materials, any appropriate alloy or other mixture of materials.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

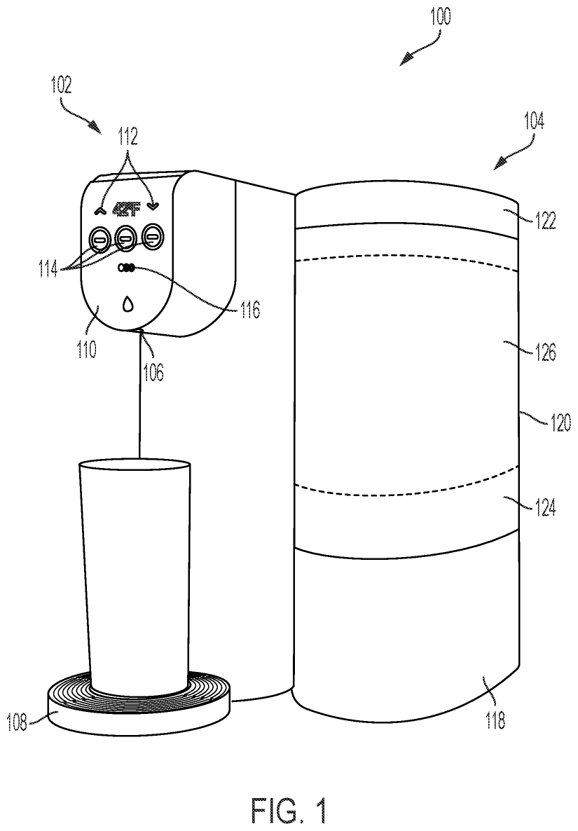

FIG. 1 is a front perspective view of one embodiment of a beverage machine. In some embodiments, a beverage machine 100 may include a housing portion 102 and a liquid supply portion 104. As will be described in more detail below, the housing portion 102 may include portions of a flow circuit of the machine 100, one or more pod receptacles, a mixing area (not shown) to mix water or other liquid with an additive from a pod, a dispensing outlet 106, and/or a drip tray 108.

In some embodiments and as shown, the housing portion 102 may further include a user interface, such as a control panel 110. The control panel 110 may comprise one or more components to permit a user to provide input to and/or output from the machine 100, e.g., to control various operations or functions of the machine 100. For example, in some embodiments, the control panel may include temperature, volume, or other control buttons 112 to allow a user to control a temperature, volume, or other characteristics of a dispensed beverage. Additionally or alternatively, the control panel 110 may include one or more additive buttons 114 that may be operatively coupled to a pod receptacle of the machine 100 (described in detail below), such that operation of an additive button 112 causes a beverage to be dispensed which includes a beverage additive contained in a pod within the corresponding pod receptacle. In some embodiments, a control button 112 may allow a user to select or adjust a concentration or flavor strength of a beverage additive in a beverage by adjusting a volume of the beverage additive dispensed from the pod. Further, in some embodiments, one or more control buttons may allow a user to select or individually adjust concentrations or flavor strengths of multiple beverage additives in a beverage by adjusting the respective volumes of each beverage additive dispensed from respective pods and mixed with liquid to form the beverage.

Additionally or alternatively, the control panel 110 may include one or more indicator lights to indicate a status of the machine or a component thereof. For example, in some embodiments, an indicator light 116 may indicate whether a pod receptacle contains a pod, how much of a beverage additive remains in a pod, whether the machine is currently executing a beverage forming or dispensing operation, a status of a filter of a machine, or any other appropriate status of the machine 100 or any component thereof.

The liquid supply portion 104 may include a base 118, a tank 120, and a lid 122. The tank 120 may be configured to contain a volume of water 126 or other liquid used to form a beverage. In some embodiments, the tank may comprise a floor and a vertical wall portion enclosing an internal volume in which a volume of water may be disposed. The lid 122 may cover an opening of the tank 120, and may be selectively removable from the tank 120 to allow the tank 120 to be refilled through the opening. In some embodiments, the liquid supply portion 104 may be capable of heating and/or cooling the volume of water 126. For examples, in various embodiments, the base portion 118 may include or otherwise be associated with thermoelectric cooler (TEC) such as a Peltier cooler, a refrigeration unit such as a vapor compression unit, a chiller, a magnetic cooling unit, a flow-through water heater, a resistive heater (e.g., using electrical resistance), a heat exchanger, a boiler, or any other appropriate heating/cooling mechanism. In some embodiments, the heating/cooling mechanism may freeze a portion of volume of water 126 to form a volume of ice 124 in order to enhance the cooling effect on the volume of water 126 and/or to facilitate the maintenance of a desired temperature in the volume of water. Additionally or alternatively, a desired temperate may be achieved in the volume of water using a recirculating flow circuit, for example by recirculating the volume of water through a cooler and back into the tank 120. Recirculation may be performed on a continuous basis, or on a temporary basis. For example, in some embodiments, recirculation may be performed in response to a temperature sensor of the machine detecting that a temperature of the volume of water has exceeded a threshold or otherwise deviated from a desired temperature.

In some embodiments, the liquid supply portion 104 may be couplable to a water source or other liquid supply to facilitate refilling the tank 120. For example, in some embodiments, the liquid supply portion 104 may be fluidly coupled to a tap, a faucet, a spigot, or another plumbed water line. In some cases, the liquid supply portion 104 need not include a tank 120, and instead may include a suitable coupling to a mains or other plumbed liquid supply that provides water or other liquid to the machine 100. As suitable, the liquid supply portion 104 can include a pump or other component to provide water or other liquid to one or more components of the machine 100.

In some embodiments, the liquid supply portion 104 or another portion of a beverage machine may be capable of carbonating a liquid. For example, in various embodiments, the machine may accept a canister or cartridge filled with a compressed gas or liquid, such as carbon dioxide. The machine may inject or dissolve gas into a liquid under pressure, and may pass the carbonated or otherwise gas-infused liquid through the machine or a portion thereof to produce a sparkling beverage.

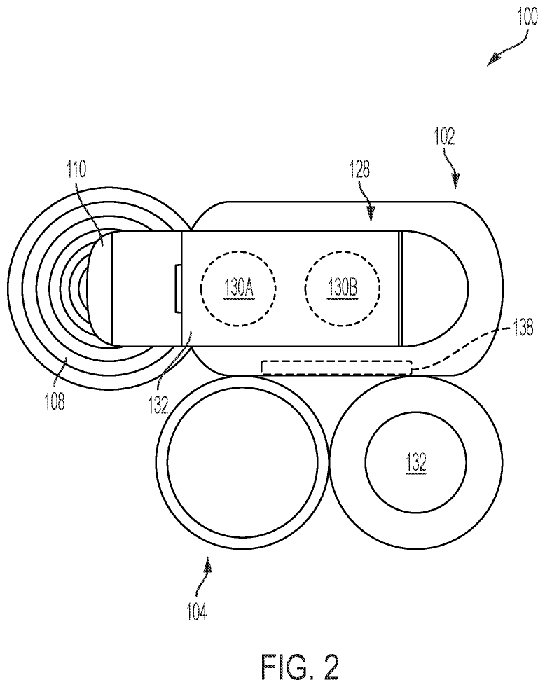

FIG. 2 depicts a top view of the embodiment of the machine 100 in FIG. 1. As shown in FIG. 2, the machine 100 may further include a beverage forming module 128, a filtration module 132, and/or a controller 138 in communication with one or more of the various modules, components, and/or subcomponents of the machine 100. A filtration module 132 may include one or more filters through which water or other liquid from a liquid supply may be passed. For example, water from the tank 120 may be passed through a filter of the filtration module 132. A filter of a beverage machine of the present disclosure may comprise any appropriate type of filter, including any appropriate carbon filter such as a granular activated carbon (GAC) filter or a carbon block filter, any appropriate microfiltration or ultrafiltration filter or membrane, any appropriate screen or cloth filter, any appropriate ion exchange filter, any appropriate reverse osmosis filter, or any other appropriate filter.

A beverage forming module of a beverage machine may be configured to form a beverage and/or to deliver a beverage to a dispensing outlet of the machine. In some embodiments, forming a beverage may include combining a beverage additive with water to form a beverage. In some embodiments, the beverage forming module may be configured to receive a pod containing a beverage additive and to dispense the beverage additive from the pod for combination with water or other liquid. For example, in some embodiments, a beverage forming module may include at least one pod receptacle. In the embodiment shown, the beverage forming module 128 may include a first pod receptacle 130A, a second pod receptacle 130B, and a third pod receptacle 130C. As described in detail below, each pod receptacle 130A, 130B, 130C may be configured to receive a pod and to dispense a beverage additive from the pod. As will be described, each pod receptacle may further be configured to selectively close and open an opening of the pod, and/or to dispense a metered amount of the beverage additive from the pod.

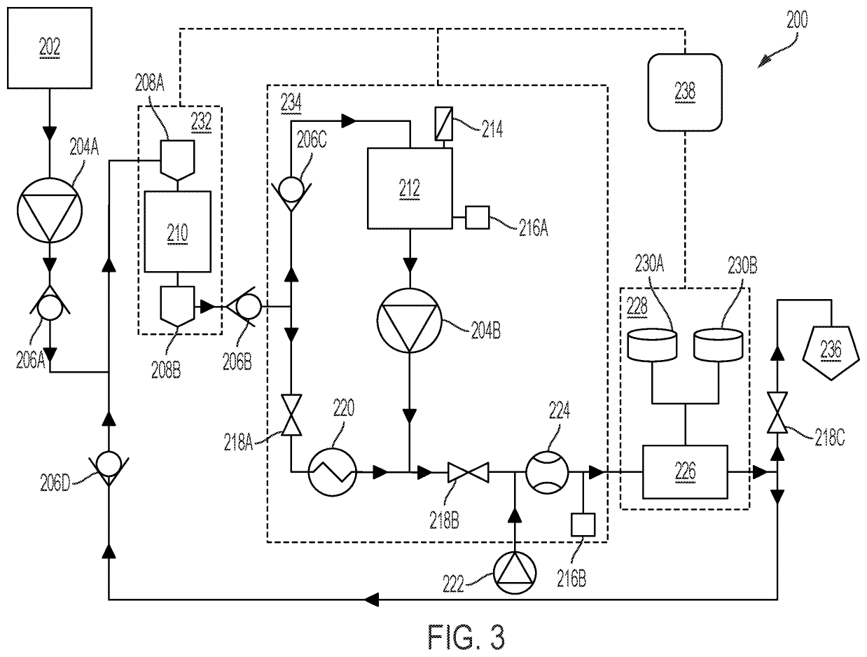

FIG. 3 is a schematic depicting a flow circuit 200 of a beverage machine according to one embodiment. It will be appreciated that the flow circuit 200 or the various modules, components, or subcomponents thereof may be controlled or operated by a controller 238 of the beverage machine, may send data or information to the controller 238, and/or may receive data, information, and/or control signals from the controller 238. Additionally, the controller 238 may be communicatively coupled to a user interface, such as a control panel 110 of the machine to receive and process input from and provide output to a user. In the flow circuit 200, a liquid source 202 may provide water to the machine. In various embodiments, the liquid source 202 may provide water or other liquid to the machine 100. For example, the water source 202 may include a water tank 120 of the machine and/or any other liquid supply portion 104, such as a tap, faucet, spigot, or plumbed water line. A first pump 204A may provide water or other liquid to at least a portion of the flow circuit 200. The pump 204A may include any appropriate pump, including any appropriate centrifugal pump, positive displacement pump, peristaltic pump, or any other appropriate pump. A first check valve 206A may be provided downstream from the first pump 204A in order to prevent backflow into the first pump 204A and/or to prevent damage to the first pump 204A.

A filtration module 232 may be provided downstream from the first check valve 206A. A filtration module may comprise at least one phase of filtration. In some embodiments, the filtration module 232 includes a filter 210, a first water quality sensor 208A upstream of the filter 210, and a second water quality sensor 208B downstream from the filter. The first and second water quality sensors may measure a quality of the water at various points in the flow, e.g., to provide an indication of effectiveness of the filter 210. A water quality sensor may comprise a total dissolved solids (TDS) meter, a refractometer, a mass spectrometer, or any other appropriate sensor for detecting a quality or other characteristic of water or other liquid. The water quality sensors may be included in the filtration module 232 in order to monitor an effectiveness or status of a filter or filtration phase. For example, in the embodiment shown, the first and second water quality sensors 208A may comprise first and second TDS meters to detect a level of dissolved solids before and after filtration, respectively. In some embodiments, this may allow the effectiveness of the filter 210 to be evaluated in real time, in order to determine whether the filter 210 or a component thereof should be replaced, cleaned or otherwise maintained in a working condition. A second check valve 206B may be included downstream from the filtration module 232, or, in alternative embodiments, may be included in a filtration module at a point downstream from one or more filters.

Although the embodiment shown is depicted as including water quality sensors to monitor an effectiveness or status of a filter or filtration phase, it will be appreciated that some embodiments may include other devices and/or methods for monitoring or measuring the effectiveness of status of a filter or filtration phase. For example, in some embodiments, a flow meter may be included to measure or track a volume of water processed by a filter. Additionally or alternatively, a pressure sensor may be included to measure a pressure drop across the filter. Additionally or alternatively, a flow meter may be included to measure or monitor a volume of liquid passed into or through a filter over time. Other embodiments may include any appropriate device or method for monitoring a filter, as the disclosure is not limited in this regard.

Downstream from the filtration module 232, the flow circuit 200 may include a temperature management module 234. The temperature management module may be configured to maintain or control a temperature of liquid in portions of the flow circuit, e.g., which are downstream from the temperature management module. Additionally or alternatively, the temperature management module may be configured to maintain or control a temperature of a beverage dispensed from a beverage machine. In some embodiments, the temperature management module may be operatively coupled with one or more temperature control buttons or other user interface of a beverage machine, such that the machine may dispense a beverage at a temperature determined by the user.

The temperature management module 234 of the illustrated embodiment may include a cold water tank 212 and a water heater 220. The water heater 220 may be any appropriate heater, including any appropriate flow-through water heater, resistive heater (e.g., using electrical resistance), heat exchanger, boiler, and/or any other appropriate heater. The cold water tank 212 may be configured to store a volume of water or other liquid. The cold water tank 212 may additionally be configured to chill, cool, refrigerate, or otherwise maintain a temperature of the liquid. For example, in some embodiments, the cold water tank 212 may include a thermoelectric cooler (TEC) such as a Peltier cooler, a refrigeration unit such as a vapor compression unit, a chiller, a magnetic cooling unit, and/or any other appropriate water cooling mechanism. In some embodiments, the chiller or cooler may freeze a portion of the volume of water in the cold water tank 212 to form a volume of ice. In some such embodiments, the volume of ice may facilitate the maintenance of a desired temperature of the water, or the ice may enhance the cooling effect on the volume of water. Further, the cold water tank 212 may include a first temperature sensor 216A to monitor a temperature of the volume of water. The temperature sensor 216A may comprise a thermocouple, a thermometer, a resistance temperature detector (RTD), and/or any other appropriate temperature sensor. In some embodiments, a breather valve 214 (or any other appropriate relief valve) may be included in the cold water tank 212 in order to prevent excess pressure from building inside the cold water tank 212. Additionally, in some embodiments, a third check valve 206C may be included upstream of the cold water tank 212 to prevent backflow from pressure which may build up inside the tank.

The temperature management module 234 may further comprise a second pump 204B and at least one shut-off valve to control flow through the temperature management module. For example, in the embodiment shown, the temperature management module 234 may include a first shut-off valve 218A and a second shut-off valve 218B. The first shut-off valve 218A may control flow through the water heater 220. For example, if a user uses a temperature control button to request a beverage at a temperature that is warmer than the temperature of water in the cold water tank 212, a controller of the beverage machine may open the first shut-off valve to allow water to flow through the water heater 220. In some embodiments or applications, the water from the water heater 220 may continue to the beverage forming module 228 and/or a dispenser 236 to dispense a warmed or heated beverage. In other embodiments or applications, the water from the water heater 220 may mix with cold water from the cold water tank 212 to deliver a beverage having a temperature determined or influenced by the relative proportions of heated water and cold water. In some embodiments, a controller of the machine may control at least one of the first and second pump 204A, 204B, in order to control the temperature of the beverage by controlling the relative proportions of heated water and cold water or other liquid.

In some embodiments, a second shut-off valve 218B, a flow meter 224, and a second temperature sensor 216B may be at a downstream end of the temperature control module 234. In some embodiments, the flow meter and/or the second shut-off valve 218B may be provided downstream from the temperature control module and separate from the temperature control module, rather than being at a downstream end of the temperature control module. The second temperature sensor 216B may be any appropriate type of temperature sensor, substantially as described with reference to the first temperature sensor 216A (although it will be appreciated that the first and second temperature sensors need not be the same or similar types of temperature sensors, as any combination of appropriate temperature sensors is also contemplated).

The flow meter 224 may be configured to measure or detect a flow rate through the flow circuit. A flow meter may be any appropriate type of flow meter, including any appropriate positive displacement flow meter, Venturi flow meter, magnetic flow meter, vortex flow meter, turbine flow meter, differential pressure flow meter, or any other appropriate type of flow meter. The flow meter 224 may be communicatively coupled to a controller of the beverage machine, such that the controller may receive data relating to a flow rate through the circuit from the flow meter. In some embodiments, the controller may additionally be communicatively coupled to at least one of the first pump 204A and the second pump 204B. In some embodiments, the controller may control operation of one or more of the pumps based, at least in part, on data provided by the flow meter 224.

The second shut-off valve 218B may be any appropriate type of shut-off valve, substantially as described with reference to the first shut-off valve 218A (although it will be appreciated that the first and second shut-off valves need not be the same or similar types of shut-off valves, as any combination of appropriate shut-off valves is also contemplated). The second shut-off valve 218B may open to permit flow to a beverage forming module 228, and the second shut-off valve 218B may close to prevent flow to the beverage forming module. Additionally, the second shut-off valve may close to control a flow of air through the flow circuit 200. For example, in some embodiments, an air pump 222 may be included in the flow circuit. The air pump 222 may be operated to purge a line of the flow circuit and/or to perform a cleaning or maintenance operation on the flow circuit or beverage machine. An air pump may be any appropriate type of air pump or air compressor, or any other appropriate air pump or compressor. In view of the purging or cleaning function of the air pump 222, the second shut-off valve 218B may be provided to selectively prevent pressurized air from flowing into upstream components of the flow circuit 200, such as the heater 220, the second pump 204B, and/or the cold water tank 212.

A beverage forming module 228 may be provided downstream from the temperature control module 234 and/or the air pump 222. In some embodiments, the beverage forming module 228 may include a mixing area 226 and one or more pod receptacles 230A, 230B. As will be described in detail below, each pod receptacle may be configured to accept a pod containing a beverage additive. Each pod receptacle 230A, 230B may further be configured to dispense the beverage additive from the pod into the mixing area 226 in order to form a beverage comprising liquid and the beverage additive. It will be appreciated that the flow circuit 200 may be operated without a pod inserted into a pod receptacle, and that in such arrangements, the flow circuit or beverage machine may provide water or other liquid as the beverage, with no beverage additive included.

A third shut-off valve 218C may be provided downstream from the beverage forming module 228. The third shut-off valve 218C may be any appropriate type of shut-off valve, substantially as described with reference to the first shut-off valve 218A (although it will be appreciated that the first, second, and third shut-off valves need not be the same or similar types of shut-off valves, as any combination of appropriate shut-off valves is also contemplated). The third shut-off valve 218C may selectively control flow from the beverage forming module 228 to the dispenser 236, e.g., including a conduit with a dispense outlet from which beverage is dispensed. When the third shut-off valve 218C is open, beverage may flow from the mixing area 226 into the dispenser 236 to be dispensed to a user. When the third shut-off valve 218C is closed, flow to the dispenser 236 may be prevented, as may be desirable when the beverage machine is not in use.

In some embodiments, a fourth check valve 206D may be included in a pressure relief channel of the flow circuit 200. In certain scenarios, a pressure relief channel may facilitate the relief of pressure that may build up within the flow circuit 200. For example, if the third shut-off valve 218C were closed and if a flow were induced through the flow circuit 200, a pressure may build up within the flow circuit to the detriment of certain components such as pumps, flow meters, or other components which may be sensitive to changes in pressure. Therefore, the fourth check valve 206D may permit flow from the mixing area to re-enter the flow circuit at an upstream point, such that any pressure may be relieved or accommodated by other components (e.g., the breather valve 214 of the cold water tank 212).

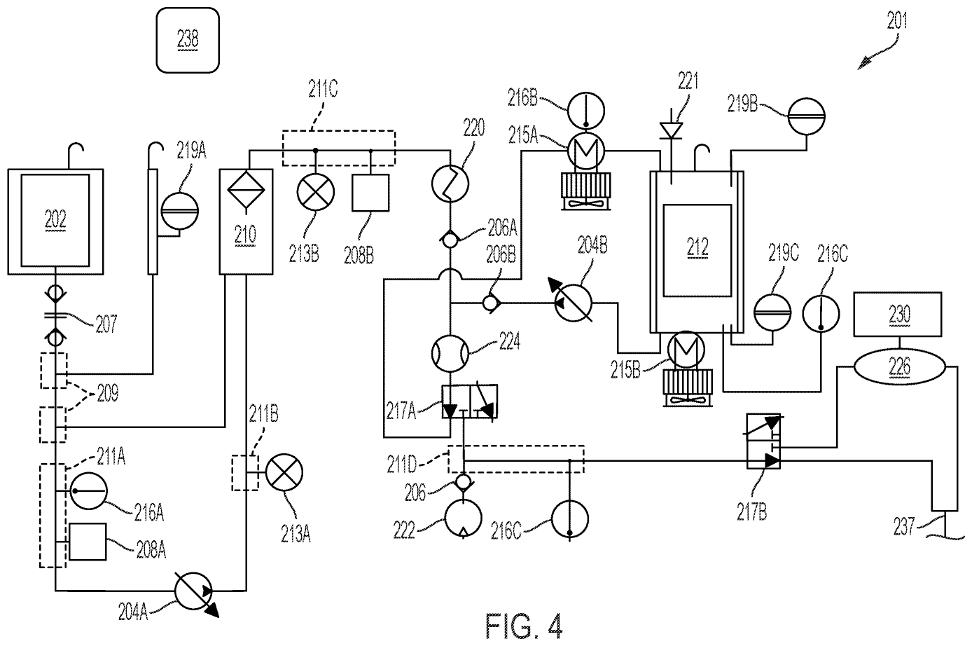

FIG. 4 is a schematic depicting a flow circuit 201 of a beverage machine according to another embodiment. It will be appreciated that many of the components of FIG. 4 are consistent with the components shown in FIG. 3. For example, the ambient water tank 202, water pumps 204, check valves 206, water quality sensors 208, filter 210, cold water tank 212, temperature sensors 216, heater 220, air pump 222, flow meter 224, mixing area 226, pod receptacle 230, and controller 238 of FIG. 4 may all be substantially as described above with reference to FIG. 3. However, it will be noted that the embodiment of FIG. 4 differs from the embodiment of FIG. 3 in that FIG. 4 may include additional components or details not specifically depicted in FIG. 3, and in that the components of FIG. 4 need not be grouped into modules. Accordingly, it will be appreciated that a flow circuit of a beverage machine according to the present embodiment may include any component, group of components, or module appropriate for carrying out the concepts described herein, as the disclosure is not limited to any particular components or any particular arrangement.

With reference to FIG. 4, some embodiments may include a first level sensor 219A in fluid communication with an ambient water tank 202 in order to monitor a fill level of a volume of liquid within the ambient water tank 202. Some embodiments may further include a mechanically actuated check valve 207. The mechanically actuated check valve 207 may be actuatable to prevent flow either to or from the ambient water tank 202. Additionally, some embodiments may include one or more tee junctions 209. Each tee junction 209 may be configured to split a flow of liquid to cause the liquid to flow in two downstream directions through the flow circuit. In some embodiments, a tee junction 209 may include a three-way valve, which may be configured to selectively allow or prevent flow in each of the two downstream directions.

Some embodiments may further include one or more manifolds 211. A manifold 211 may allow certain components to access to the flow circuit. For example, a manifold 211 may be provided in fluid communication with a temperature sensor, a TDS meter, a pressure sensor, an air pump, or any other appropriate component to all the component to access the flow circuit at any appropriate point in the flow circuit. As shown in FIG. 4, a first manifold 211A may be provided in fluid communication with a first temperature sensor 216A and a first TDS meter 208A at a point upstream of a first pump 204A and a filter 210. A second manifold 211B may be provided in fluid communication with a first pressure sensor 213A at a point upstream of the filter 210 but downstream of the first pump 204A. A third manifold 211C may be provided in fluid communication with a second pressure sensor 213B and a second TDS meter 208B. A controller 238 may obtain data from the first and second TDS meters 208A, 208B and/or from the first and second pressure sensors 213A, 213B in order to determine an effectiveness or status of the filter 210, as described above.

In some embodiments, a flow circuit may include a selector valve configured to allow liquid to flow in one of two separate downstream directions. For example, the embodiment of FIG. 4 may include a first selector valve 217A. The first selector valve 217A may be configured to direct flow towards either a mixing area 226 or a second selector valve 217B. With the first selector valve 217A arranged to direct flow towards the cold water tank 212, the liquid may first pass through a first thermoelectric cooler (TEC) 215A to cool the liquid at a point upstream of the cold water tank 212. The first TEC 215A may be in communication with a second temperature sensor 216B. The controller 238 may obtain temperature data from the second temperature sensor 216B to determine an appropriate power level or working status for the first TEC 215A to achieve a desired temperature.

In some embodiments, an ultraviolet (UV) light 221 may be provided in conjunction with the cold water tank 212. The UV light 221 may comprise a light-emitting diode (LED) or any other suitable light which may be configured to emit ultraviolet light into or onto the cold water tank 212 in order to prevent growth of microbiota such as algae or bacteria in the cold water tank 212 or to disinfect the cold water tank 212. The cold water tank 212 may further be provided in fluid communication with one or more fill level sensors to monitor or detect a fill level of the cold water tank. For example, a high level sensor 219B may be provided to detect when the cold water tank 212 has been filled to a threshold or maximum volume. Additionally or alternatively, a low level sensor 219B may be provided to detect when the cold water tank 212 has been emptied to a threshold or minimum volume. The controller may obtain data from a fill level sensor and may control operation of a pump (e.g., the first pump 204A) to maintain a desired fill level based on the fill level sensor data.

In some embodiments, a second TEC 215B may be provided in thermal communication with the cold water tank 212 or a volume of liquid contained therein. The second TEC 215B may perform a maintenance cooling function as described above, in order to maintain a desired temperature of liquid within the cold water tank. In some embodiments, the second TEC 215B may freeze a portion of the volume of liquid as described above. A third temperature sensor 216C may be in communication with the cold water tank 212 in order to monitor a temperature of a liquid contained therein. The third temperature sensor 216C may provide temperature data to the controller 238 such that the controller may control a power setting or working status of the second TEC 215B in order to maintain a desired temperature within the cold water tank.

A second pump 204B may be provided downstream of the cold water tank 212. When the first selector valve 217A is configured to direct flow towards the cold water tank 212, the second pump 204B may be operated to recirculate liquid through a cooling circuit including the first TEC 215A and the cold water tank 212. It will be appreciated that a first check valve 206A may close the cooling circuit by preventing liquid from flowing back towards the filter 210 when the second pump 204B is operated. The controller 238 may recirculate liquid through the cooling circuit, for example, when a temperature of a liquid in the cold water tank 212 is above a threshold value.

When the first selector valve 217A is configured to direct flow towards the second selector valve 217B, the second pump 204B may be operated to direct liquid from the cold water tank 212 to the second selector valve 217B. Additionally or alternatively, the first pump 204A may be operated to direct liquid from the ambient water tank 202 to the second selector valve 217B. In some embodiments, liquid from the ambient water tank 202 may be warmed or heated by the optional heater 220. A third temperature sensor 216C may be provided downstream of the first selector valve 217A in order to monitor or detect a temperature of a liquid directed towards the second selector valve 217B. The controller 238 may obtain temperature data from the third temperature sensor 216C and control cooperation between or among the first pump 204A, the second pump 204B, and/or the heater 220 in order to produce a desired temperature at the third temperature sensor 216C. In some embodiments, the controller may control the cooperation of the pumps and/or the heater in real time to control or change a proportion of ambient water, a proportion of heated water, and/or a proportion of cold water. This real-time cooperation may allow the machine to control a beverage temperature in response to a user selecting or changing a desired beverage temperature. The third temperature sensor 216C may be provided in fluid communication with a fourth manifold 211D, which may further be in fluid communication with an air pump 222. The air pump 222 may be used to purge or clean a portion of the flow circuit, as described above with reference to FIG. 3.

The second selector valve 217B may be provided downstream of the first selector valve 217A. The second selector valve 217B may direct flow either directly to the dispensing outlet 237 or to the mixing area 226. In some embodiments, flow may be directed directly to the dispensing outlet 237 when a user has indicated that a liquid is desired without any beverage additive mixed in with the liquid. For example, when a user wants water alone, the controller 238 may direct the second selector valve 217B to direct flow directly to the dispensing outlet. When the user wants a beverage additive mixed into a liquid to produce a beverage, the controller 238 may direct the second selector valve 217B to direct flow to the mixing area 226. In the mixing area 226, a beverage additive may be dispensed from a pod disposed within a pod receptacle 230 be mixed with the liquid in the flow circuit. This dispensing and mixing process is described throughout the present disclosure.

It will be noted that FIG. 4 depicts the controller 238 separately from the flow circuit 201. However, it will be appreciated that the controller is so depicted for clarity of illustration only, and that the controller may be in electrical communication with any individual component of the flow circuit 201 in order to send signals to or receive signals from the various components. In various embodiments, a controller may be in communication with any or all appropriate components of a beverage machine according to the present disclosure, including any or all appropriate components of a flow circuit of the machine.

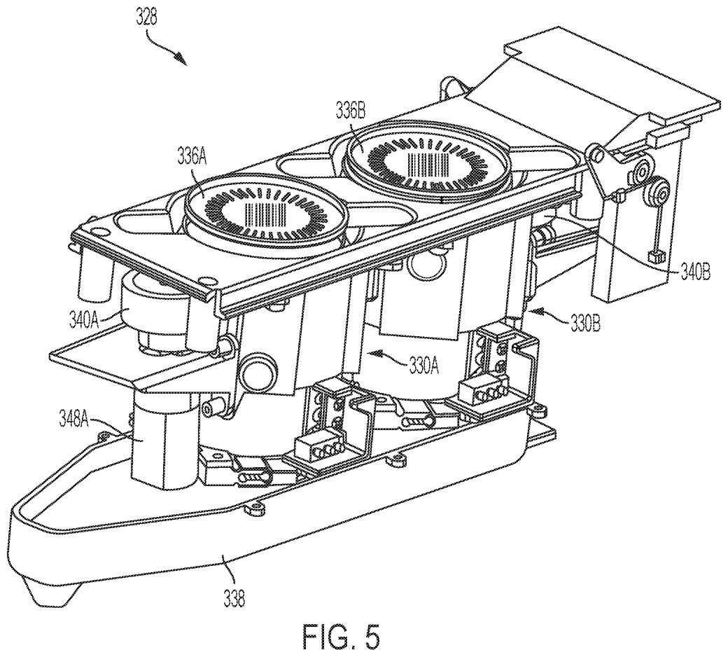

FIG. 5 depicts a beverage forming module 328 of a beverage machine according to one embodiment. The beverage forming module 328 may include a first pod receptacle 330A configured to receive a first pod 336A and a second pod receptacle 330B configured to receive a second pod 336B. Each of the first pod receptacle 330A and the second pod receptacle 330B may be configured to dispense a beverage additive from a pod into a mixing area 338. In some embodiments, each pod receptacle may include one or more pod control mechanisms configured to engage with a pod. For example, each pod receptacle may include a pod drive mechanism configured to engage with a pod or a portion of a pod and configured to cause a movement of the pod or the portion of the pod. Additionally or alternatively, each pod receptacle may include one or more pod retention mechanisms configured to engage with a pod or a portion of a pod and configured to prevent or resist a movement of the pod or the portion of the pod. Pod control mechanisms, including pod drive mechanisms and/or pod retention mechanisms, may be configured to dispense the beverage additive from the pod into the mixing area. For example, as will be described in greater detail below, the pod control mechanisms may be configured to cause a relative movement between two parts of a pod in order to close and/or open an opening of the pod and/or dispense additive from a pod.

In the embodiment shown, the first pod receptacle 336A may include a pod drive mechanism comprising a first pod drive wheel 340A coupled to a first motor 348A, and the second pod receptacle 336B may include a pod drive mechanism comprising a second pod drive wheel 340B coupled to a second motor (blocked from view in FIG. 4). Each pod drive wheel may be configured to engage with a pod or a portion of a pod, for example through a frictional engagement with an outer surface of the pod or the portion of the pod. The frictional engagement may be such that when a motor of the beverage machine turns the pod drive wheel, the rotation of the pod drive wheel causes a corresponding rotation of the pod or the portion of the pod. In some embodiments, the rotation of the pod drive wheel may further cause a corresponding translation of the pod or the portion of the pod, for example by disposing the pod drive wheel at an angle relative to the pod. This configuration will be described in greater detail below.

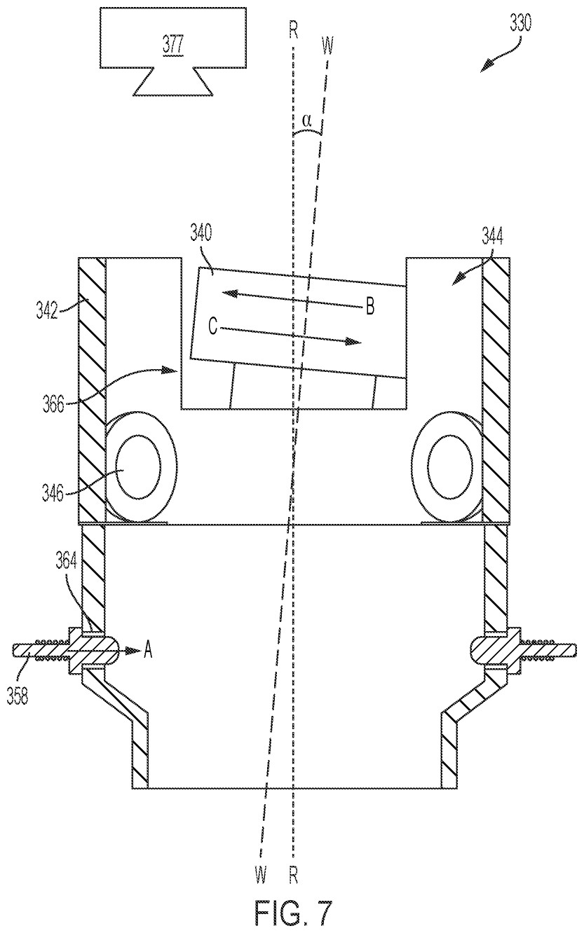

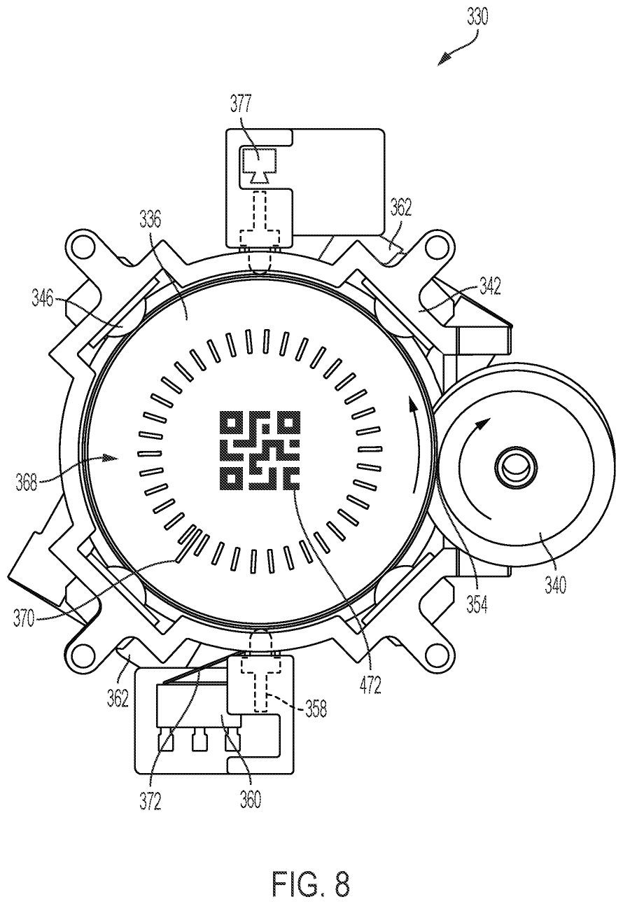

Additionally, in the embodiment shown, each pod receptacle may include one or more pod retention pins or detents (blocked from view in FIG. 5; best seen in FIGS. 7-8) configured to engage with a pod or a portion of a pod, for example by a spring-biased engagement with one or more notches or ridges of the pod. The retentive engagement may be such that when the pod drive wheel causes a rotation and/or a translation of a first portion of the pod, a corresponding movement of a second portion of the pod is prevented or resisted or movement of the first portion of the pod is caused. As described below, the retentive engagement may be selective, such that the pod retention mechanism (e.g., a pod retention pin or detent) may selectively engage or disengage from the pod or the portion of the pod. This configuration may allow a first portion of a pod to be retained by the one or more pod retention mechanisms while a second portion of the pod is moved by the pod drive mechanism or allow the first portion to be engaged by the pod drive mechanism, e.g., for rotation of the first portion relative to the second portion. In some embodiments, this relative movement may close and/or open an opening of the pod to dispense a beverage additive from the pod.

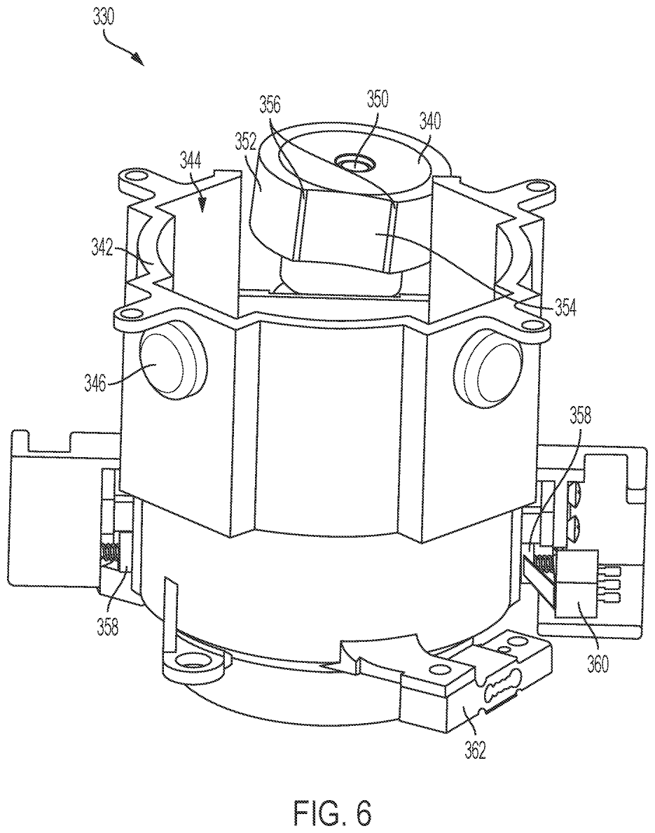

FIG. 6 depicts a single pod receptacle 330 of a beverage forming module of a beverage machine according to some embodiments. As shown, the pod receptacle 330 may include a wall 342 that may at least partially define a volume 344. The volume 344 may be sized and shaped to accommodate at least part of a pod, with the wall 342 being shaped to form the volume accordingly. For example, a volume may be generally cylindrical in order to receive a pod which is generally cylindrical. In some embodiments, the wall 342 may optionally include one or more reference features configured to contact a pod disposed within the volume 344 such that the pod is maintained in a consistent, predictable position each time it is inserted into, removed from, or moved within the pod receptacle 330. For example, in some embodiment, the wall 342 may include one or more roller elements 346. Each roller element 346 may comprise a round ball partially contained within a housing, with a portion of an external surface of the ball exposed outside of the housing. The ball may be free to roll or rotate within the housing with minimal friction, such that an external surface of a pod which is in contact with the external surface of the ball may be free to move in directions tangent to the external surface of the ball. Accordingly, a roller element 346 may provide a discrete contact point along the wall 342 of the pod receptacle without constraining or impeding movement of the pod within the volume 344. Additionally, in some embodiments, a roller element 346 may include a spring cooperating with the ball inside the housing to bias the ball towards a center of the volume 344. In addition to the benefits noted above, a spring-loaded roller element may alleviate a misalignment resulting from manufacturing tolerances within the machine and/or the pod, or the spring-loaded roller element may improve an ability of the pod receptacle 330 to accommodate pods having slight variations in size. Note that in some embodiments, other pod guiding or support components than a roller element may be used, such as fins, pins, wheels, etc. that may be fixed or movable in at least one direction.

As noted above, the pod receptacle 330 may include one or more pod control mechanisms configured to engage with a pod. For example, as noted, a pod control mechanism may comprise a pod drive mechanism configured to engage with and cause a movement of a pod or a portion of a pod (e.g., a cap and/or a reservoir of a pod), or a pod control mechanism may comprise a pod retention mechanism configured to engage with and prevent a movement of a pod or a portion of a pod (e.g., a cap and/or a reservoir of a pod). In the embodiment of FIG. 6, the pod receptacle 330 may include both a pod drive mechanism and a pod retention mechanism. As will be described, the pod retention mechanism may selectively engage with and prevent a movement of a first part of a pod, while the pod drive mechanism may selectively engage with and cause a movement of a second part of a pod, thereby causing a movement of the second part relative to the first part. This relative movement may cause an opening of the pod to be opened to allow a beverage additive within the pod to be dispensed.

In some embodiments, the pod receptacle 330 may include a pod drive mechanism comprising a pod drive wheel 340. The pod drive wheel 340 may be operatively coupled to a motor (blocked from view; see motor 348A of FIG. 5) via a drive shaft 350, and may be configured to engage with a pod or a portion of a pod. In some embodiments, the pod drive wheel 340 may be configured to frictionally engage with a pod or a portion thereof. For example, the pod drive wheel may have a drive surface 352 around at least part of a circumference of the drive wheel. In some embodiments, the drive surface may have a surface roughness sufficient to engage an external surface of a pod or a portion of a pod, and to cause a rotation of the pod or the portion thereof when the pod drive wheel 340 is rotated by the motor. Additionally or alternatively, in some embodiments, the drive surface may include a coating, such as an engineered coating, to facilitate the frictional engagement between the pod drive wheel and the external surface of the pod.

The surface roughness of the pod drive wheel 340 and/or the frictional engagement between the pod drive wheel and a pod may inhibit or prevent the pod from being easily inserted into or removed from the pod receptacle 330. Although this may be desirable in some applications or during some modes of operation, it may also be desirable to facilitate the insertion or removal of a pod in other applications or during other modes of operation. Accordingly, the pod drive wheel 340 may be configured to facilitate the insertion or removal of a pod. For example, in the embodiment shown, a circumference of the pod drive wheel 340 may include a groove 354, such that the pod drive wheel 340 may be non-circular or non-continuous around a portion of its perimeter. The groove 354 may be sized and shaped to correspond to a portion of a circumference, a diameter, or an outer surface of a pod, such that the frictional engagement provided by the drive surface 352 may be at least partially disengaged when the pod drive wheel 340 is at a disengagement position wherein the groove 354 is in rotational alignment with the pod. That is, in the disengagement position, the groove 354 may face toward the pod and/or a volume defined by the pod receptacle 330 so the drive wheel 340 does not contact or reduces a contact force with a pod in the pod receptacle 330. This disengagement may facilitate the insertion or removal of a pod when the pod drive wheel 340 is at the disengagement position. Accordingly, if a controller of a beverage machine receives information indicating that a user intends to insert or remove a pod, the controller may actuate the pod drive wheel 340 to the disengagement position to facilitate the insertion or removal.

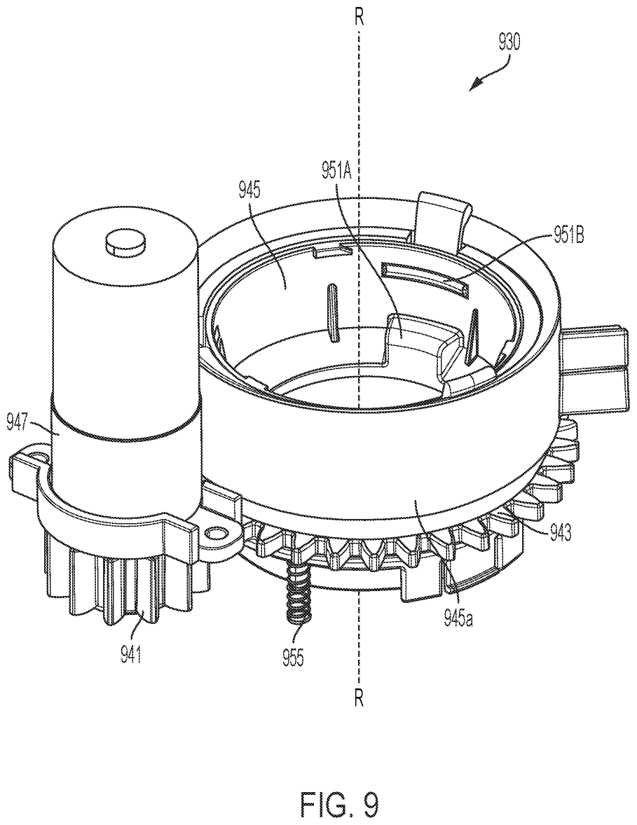

In addition to the above, it may be desirable, in some embodiments or modes of operation, to cause an agitation of a beverage additive within a pod. For example, in some embodiments in which the beverage additive is provided in a powdered form, agitation of the beverage additive may facilitate dispensing of the powder by fragmenting any clumps which may have accumulated in the powder. In some embodiments, the pod drive mechanism may be configured to impact, vibrate, shake, or otherwise disturb the pod to agitate the beverage additive. For example, in the embodiment of FIG. 6, the pod drive wheel 340 may include a groove 354 having one or more corners 356 configured to impact, vibrate, shake, or disturb the pod. In some embodiments, the pod drive wheel 340 may be rotated in order to move a pod within the pod receptacle 330, or to move a first portion of a pod relative to a second portion of the pod in order to dispense a beverage additive from the pod. This may be accomplished by a frictional engagement between the pod drive wheel 340 and the pod, e.g., with the reservoir or cap of the pod. However, as noted above, the frictional engagement may be disrupted when the pod drive wheel 340 is in a disengagement position, at which the groove 354 is aligned with or facing the pod. In some embodiments, the interface or transition between the drive surface 352 and the groove 354 may be formed as a corner, such that the corner causes an impact between the pod drive wheel 340 and the pod as the drive wheel passes through the disengagement position during rotation. That is, as the drive wheel 340 rotates, the drive wheel 340 may disengage from the pod, causing the pod to stop movement with the drive wheel 340, when the groove 354 faces the pod. As the drive wheel 340 continues rotation, however, a corner 356 or other edge of the groove 354 may contact the pod, causing an impact on the pod as the drive wheel 340 reengages with the pod. This impact may cause the pod to rotate suddenly, tilt, shake or otherwise move irregularly, which may agitate additive in the pod. It will be appreciated that, in other embodiments, the interface or transition between the drive surface 352 and the groove 354 may alternatively be formed smoothly to provide a smooth interaction between the pod drive wheel and the pod as the drive wheel passes through the disengagement position. However, even a smooth transition may cause intermittent or otherwise irregular movement of the pod. It will further be appreciated, particularly with reference to FIG. 9, that other methods and structures for imparting an agitating force to the pod are also contemplated, as the disclosure is not limited to the grooved drive wheel shown in FIGS. 6-7.

In some embodiments as noted above, a pod receptacle 330 may include a pod retention mechanism. For example, in the embodiment shown, the pod receptacle 330 may include two pod retention mechanisms, each comprising a detent. In some embodiments and as shown, each detent may comprise a spring pin 358. In some embodiments, a detent or a spring pin may be operatively coupled to a switch 360 such that the switch may detect a movement of the spring pin to detect when the spring pin is engaged with or disengaged from a pod. In some embodiments in which a detent comprises a spring pin 358 as shown, the spring pin may partially extend into the volume 344 through a through-hole of the wall 342. A spring of the spring pin may bias the pin towards a longitudinal axis of the pod receptacle 330. The spring pin may extend far enough into the volume 344 that a pod inserted into the pod receptacle 330 may contact, rest upon, or engage with the spring pin. Although details of the interactions between a spring pin and a pod will be described below, it should be appreciated at this point that a pod which is engaged with a spring pin may overcome the spring bias to push the spring pin 358 in a direction away from the longitudinal axis of the pod receptacle, and that this movement of the spring pin 358 may be detectable by the switch 360. Such movement of the spring pin 358 may permit the pod to be further received into the pod receptacle 330.

Additionally, in some embodiments, a pod receptacle may be configured to measure or detect an amount of a beverage additive dispensed from a pod. In some embodiments, the pod receptacle may include a sensor for measuring or detecting the amount of beverage additive dispensed. For example, in the embodiment shown, the pod receptacle 330 may include one or more load cells 362. A load cell 362 may support at least a portion of a weight of the pod receptacle 330, which may include at least a portion of a weight of a pod disposed within the pod receptacle 330. The load cell 362 may be configured to measure the supported weight, including a weight of the pod and/or a weight of any beverage additive within the pod. Accordingly, the load cell 362 may take a weight measurement before, during, and/or after a dispensing operation which may be carried out by the pod receptacle 330. In some embodiments, a load cell or other sensor configured to measure or detect an amount of beverage additive dispensed may be communicatively coupled to a controller of the beverage machine, such that the controller may obtain information regarding the dispensed amount and may calculate various parameters, including whether further dispensing is appropriate or whether a pod should be closed to terminate a dispensing operation.

Operation of a pod drive mechanism and a pod retention mechanism for some embodiments are shown in the cross-sectional side view of FIG. 7. In the side view, it can be seen that a spring pin 358 may extend through a through-hole 364 of the wall 342 into the volume 344. Although the wall 342 of the embodiment shown is depicted as comprising two separate pieces, it will be appreciated that, in other embodiments, a wall of a pod receptacle may be formed as a single piece or as more than two pieces, as the disclosure is not limited in this regard. Additionally, a spring pin 358 of this configuration may be biased in the direction of arrow A, such that a pod which is inserted into the pod receptacle 330 may be retained due, at least in part, to the spring force acting on the pod. In some embodiments such as FIG. 7, a spring pin 358 or other engagement feature may engage with a cap of a pod; in some embodiments, a spring pin 358 or other engagement feature can engage with a reservoir of a pod.

As shown in FIG. 7, a window 366 may be formed in the wall 342 to allow the pod drive wheel 340 to interact or engage with a pod when the pod is disposed within the volume 344. As noted above, the drive wheel 340 may be configured to cause a pod or a portion of a pod to move when the pod is disposed within the pod receptacle 330. In addition to the rotational movement described above, a translational movement resulting from the pod drive wheel's engagement with the pod will now be described. In some embodiments such as FIG. 7, the drive wheel 340 may engage with a reservoir of a pod; in some embodiments, a drive wheel may engage with a cap of a pod.

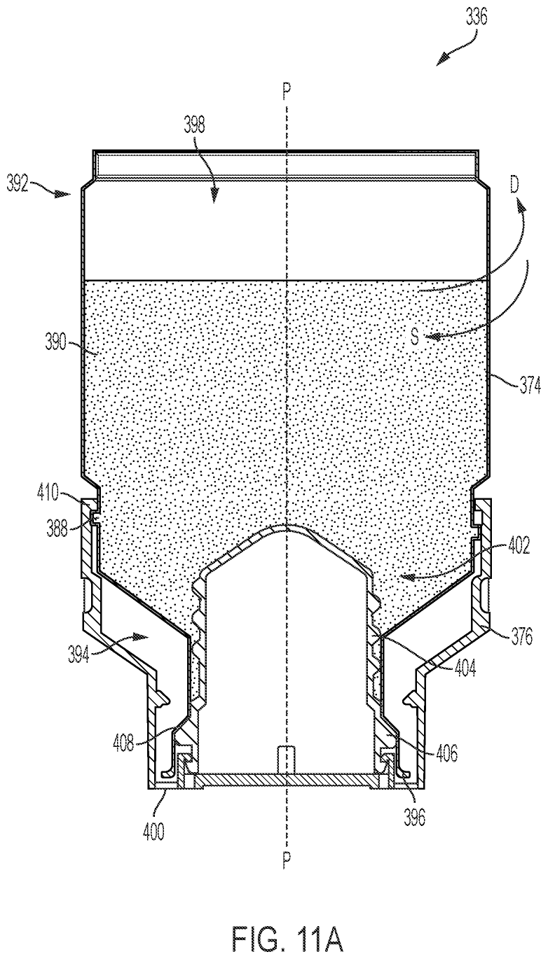

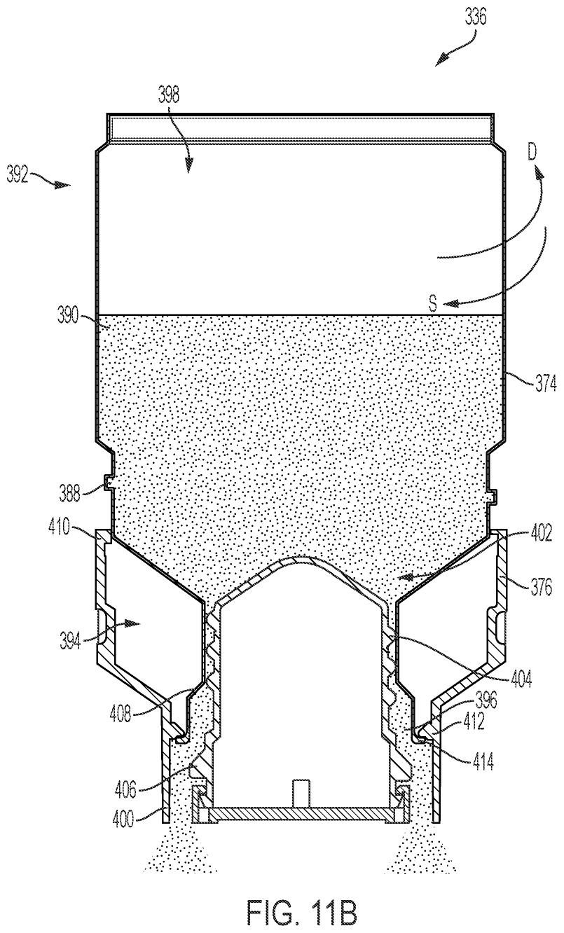

In some embodiments, it may be desirable to move a pod or a portion of a pod in a translational direction in addition to or instead of moving the pod or the portion thereof in a rotational direction. In some embodiments, the insertion or removal of a pod may be facilitated by a translational movement into or out of a pod receptacle. Additionally or alternatively, the dispensing of a beverage additive from a pod may be facilitated by a translational movement of a first portion of a pod relative to a second portion of a pod. Accordingly, in some embodiments, a pod drive mechanism may be disposed at an angle appropriate for creating a translational movement. For example, in the embodiment shown, the pod drive wheel 340 may be disposed such that a rotational axis W-W of the drive wheel may be at an angle a with respect to a longitudinal axis or other rotational axis R-R of the pod receptacle. It will be appreciated that, in some embodiments, the longitudinal axis R-R of the pod receptacle may coincide with or correspond to a longitudinal axis of a pod (see axis P-P of FIG. 11A) when the pod is disposed in the pod receptacle, and the pod may rotate about the longitudinal axis R-R when driven by the drive wheel 340.

In some embodiments, the angle a between the rotational axis W-W of the drive wheel and the longitudinal axis R-R of the pod receptacle may greater than or equal to 1°, 2.5°, 5°, 7.5°, 10°, or any other appropriate angle. Additionally, the angle a may be less than or equal 5°, 7.5°, 10°, 12.5°, 15°, or any other appropriate angle. Combinations of the foregoing are also contemplated, including greater than or equal to 1° and less than or equal to 15°, greater than or equal to 2.5° and less than or equal to 7.5°, and/or any other appropriate combination of the foregoing. Of course, while particular ranges for the angle between the rotational axis W-W of the drive wheel and the longitudinal axis R-R of the pod receptacle are provided above, it should be appreciated that other ranges both greater than and less than those noted are also contemplated as the disclosure is not limited in this regard.

Accordingly, when the pod drive wheel 340 is rotated in a clockwise first direction (clockwise when viewed from the top, as shown in FIG. 8) indicated by arrow B, the pod or a portion thereof may concurrently be rotated counterclockwise and translated in a direction out of the volume 344 (i.e., the translation may be in an upward direction when viewed from the perspective of FIG. 7). Therefore, rotation in the first direction may facilitate removal of a pod from the pod receptacle 330, and rotation in the second opposite direction may cause the pod to be received into the pod receptacle 330. Additionally or alternatively, in some embodiments in which a first portion of the pod may be moved in relation to a second portion of the pod, rotation in the first direction may cause the first portion to be both rotated and translated relative to the second portion when the second portion is engaged by the pod retention mechanisms, detents, or spring pins 358. In some embodiments in which a translation of the first portion away from the second portion may open an opening of the pod, the angled positioning of the pod drive wheel 340 may facilitate opening the opening.

Conversely, when the pod drive wheel 340 is rotated in a counterclockwise second direction (when viewed from the top, as shown in FIG. 8) indicated by arrow C, the pod or a portion thereof may concurrently be rotated clockwise and translated in a direction further into of the volume 344 (i.e., the translation may be in a downward direction when viewed from the perspective of FIG. 7). Therefore, rotation in the second direction may facilitate insertion of a pod into the pod receptacle 330. Additionally or alternatively, in some embodiments in which a first portion of the pod may be moved in relation to a second portion of the pod, rotation in the second direction may cause the first portion to be both rotated and translated relative to the second portion when the second portion is engaged by the pod retention mechanisms, detents, or spring pins 358. In some embodiments in which a translation of the first portion towards the second portion may close an opening of the pod, the angled positioning of the pod drive wheel 340 may facilitate sealing or other closing of the opening.

In addition to the pod retention and drive mechanisms, FIG. 7 also includes a schematic depiction of a sensor 377 which may optionally be included in cooperation with a pod receptacle 330. A sensor may be included in a beverage machine in order to detect one or more indicia of a pod within the pod receptacle 330, or to detect the presence or absence of a pod in the pod receptacle. (See the description of FIG. 8 for further details regarding the visual indicia.) In various embodiments, a sensor 377 may be an optical sensor, including a camera, a bar code reader, a quick response (QR) code reader, or any other appropriate optical sensor. Additionally or alternatively, a sensor 377 may be a radio frequency identification (RFID) scanner to detect an RFID tag of the pod, a near-field communication (NFC) scanner to detect an NFC chip of the pod, or a proximity sensor to detect the presence, absence, or proximity of a pod in relation to the pod receptacle. A sensor of may be included at any appropriate location or position of the machine, including at any appropriate location or position with respect to a pod receptacle 330. In some embodiments, a sensor 377 may be disposed above the pod receptacle 330 as shown in FIG. 7, such that the sensor 377 may detect one or visual indicia on a top surface of a pod. In other embodiments, a sensor 377 may additionally or alternatively be included within the pod receptacle 330. For example, in some embodiments, a sensor may be embedded within the wall 342, or a sensor may be configured to detect a visual indicium through a through-hole of the wall 342.

As shown in the top view of FIG. 8, a sensor 377 may additionally or alternatively be disposed on a side of the pod receptacle 330 in order to detect an indicium of a pod 336, which may be configured to be detectable by the sensor. In various embodiments, a pod may include one or more indicia configured to convey information about the pod to a sensor of a machine. In some embodiments, a pod may include one or more visual indicia on at least one external surface of the pod to indicate or convey information about the pod to a controller of the machine via an optical sensor, such as a position of the pod, a portion of the pod facing the sensor, information regarding an additive in the pod, etc. Additionally or alternatively, a pod may include an RFID tag to communicate data related to the pod to an RFID scanner of the machine or an NFC chip to communicate data related to the pod to an NFC scanner of the machine. In some embodiments, an indicium may convey information regarding the contents of the pod, including nutritional information, information about the constituents of a beverage additive, information indicating an appropriate volume of the beverage additive to dispense in various operating modes or applications, or any other appropriate information about the beverage additive within the pod. In some embodiments, this contents-related information may be stored and/or communicated via a one-dimensional matrix such as a bar code (see FIG. 5); a two-dimensional matrix such as a quick response (QR) code 472; a three-dimensional pattern including bumps, notches, or other textured features; a magnetic feature such as an encoded magnetic strip; a color, pattern of colors, or gradient of colors; or any other appropriate pattern or feature. In some embodiments, a controller may calculate a predetermined volume of beverage additive to be dispensed based, at least in part, on information relating to the contents of a pod.

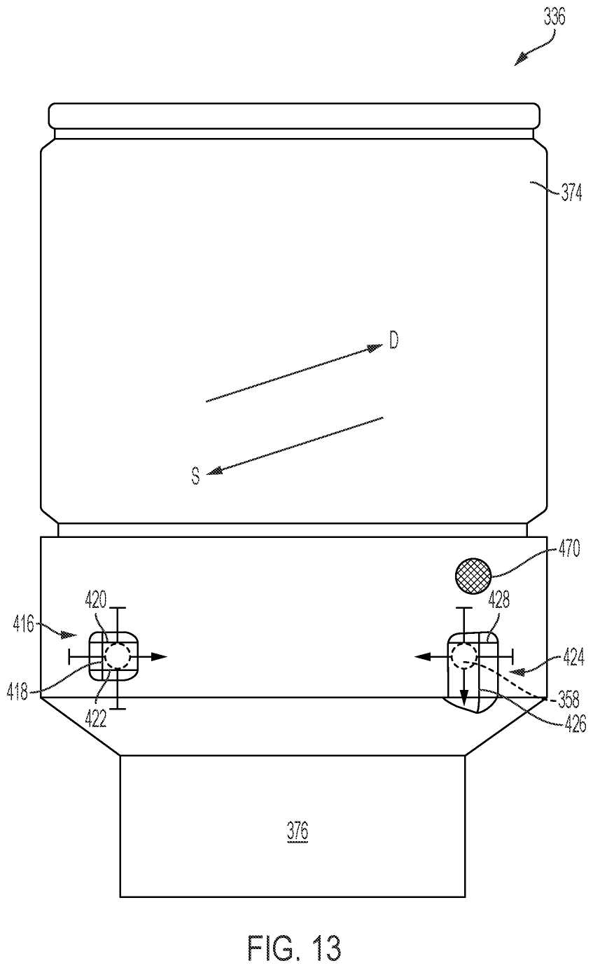

Additionally or alternatively, some indicia may comprise a visual indicium or an orientation marker to convey information about a condition or position of the pod in the pod receptacle 330. For example, as shown in FIG. 8, a non-uniform radial pattern 368 may be included to allow a controller of the machine to determine a rotational position or orientation of the pod. A non-uniform radial pattern 368 may comprise a series of radial lines marked or formed on a top surface of the pod 336 and/or on a side surface or sidewall of the pod. A majority of the radial lines may be uniform in length and/or distribution or spacing around a center point of the top surface and/or around a longitudinal axis of the pod. However, one or more radial lines may be longer or shorter than the majority, and/or one or more radial lines may have a different spacing than the majority. For example, in the embodiment of FIG. 8, a non-uniform radial line 370 may be longer than the majority of the radial lines in the radial pattern 368, and the non-uniform radial line 370 may be spaced closer to one or more adjacent radial lines than the majority of radial lines in the radial pattern 368. An optical sensor configured to scan or otherwise image the top surface of the pod 336 may detect a rotational position of the non-uniform radial line 370. The rotational position of the non-uniform radial line 370 may indicate a rotational position of the pod 336. Additionally or alternatively, in some embodiments, a visual indicium on a side surface of a pod may similarly indicate a rotational position of the pod 336 within the pod receptacle 330. For example, a visual indicium on a side surface may indicate when the pod 336 is in a rotational position which corresponds to an engagement between the pod 336 and a pod retention mechanism such as a detent or spring pin 358, such that a sensor 377 configured to scan the side surface may detect when the pod 336 is engaged with the spring pin 358. FIG. 13 depicts one example of a visual indicium 470 provide on a side surface of a cap 376 adjacent to a notch and configured to be detectable by a sensor to indicate when the pod is engaged with a pod retention mechanism.

In addition to the above-described detection of an engagement between a pod and a pod retention mechanism, the pod receptacle 330 may be configured to detect the engagement between a pod and a pod retention mechanism in any other suitable manner. In some embodiments, the pod receptacle may be configured to detect the engagement using an electromechanical switch. For example, a switch 360 may have an arm 372, which may be engaged with or attached to a spring pin 358. In this arrangement, when the pod 336 engages with and compresses the spring pin 358, the movement of the spring pin causes a corresponding actuation of the arm 372. The actuation of the arm 372 may trigger the switch 360. A controller of the machine may be communicatively coupled to the switch 360, such that triggering of the switch may indicate to the controller that a pod has been engaged with or disengaged from the spring pin 358.

Although the embodiment of FIG. 8 depicts two spring pins 358 on opposing sides of the pod receptacle 330, it will be appreciated that a pod receptacle of a beverage machine may have any appropriate number of pod retention mechanisms, detents, or spring pins, and that the pod retention mechanisms, detents, or spring pins may be disposed in any appropriate spacing or configuration. Additionally, although one of the spring pins 358 of FIG. 8 is associated with a switch 360 and the other is associated with a sensor 377, it will be appreciated that, in other embodiments, a pod retention mechanism, detent, or spring pin may be associated with both a switch and a sensor. Further, in other embodiments, a pod retention mechanism, detent, or spring pin may not be associated with either a switch or a sensor, as the disclosure is not limited with respect to the relationship between pod retention mechanisms and any sensors or switches.

FIG. 9 depicts another embodiment of a pod receptacle 930. FIG. 9 provides one embodiment in which the pod receptacle may be configured to open a pod by moving a cap relative to a reservoir of the pod, rather than by moving the reservoir relative to the cap. In some embodiments, a pod retention mechanism may be configured to resist movement of a reservoir of a pod, while a pod drive mechanism may be configured to move a cap of the pod relative to the reservoir. In some such embodiments, the pod drive mechanism may include a drive wheel substantially similar to the one described above, except that the drive wheel may be positioned and configured to drive movement of the cap rather than the reservoir.

In some embodiments, a pod drive mechanism may include additional or alternative mechanisms to achieve relative movement between the cap and the reservoir to open the pod. For example, in the embodiment of FIG. 9, the pod drive mechanism may include a movable cap retainer 945, which may be configured to engage with a cap such that the movement of the cap retainer may cause a corresponding movement of the cap (and/or vice versa—such that the movement of the cap may cause a corresponding movement of the cap retainer). When movement of the reservoir is resisted by a pod retention mechanism as disclosed herein, the movement of the cap relative to the reservoir may open an opening of the pod as described herein. For example, the movable cap retainer 945 may include one or more detents, and each detent may be configured to engage with a corresponding notch of the cap to allow cooperative movement between the cap and the cap retainer. It will be appreciated that, when the cap and cap retainer are engaged to allow such cooperative movement, a movement of one of the cap or the cap retainer may cause a corresponding movement of the other of the cap or the cap retainer.

For example, a first detent 951A may be configured to engage with a correspondingly-shaped first notch of the cap to allow cooperative rotation between the cap and the cap retainer. In this regard, rotation of the first detent 951A (e.g., by rotation of the gears 941, 943) may cause a corresponding rotation of the cap. Additionally or alternatively, a second detent 952B may be configured to engage with a correspondingly-shaped second notch of the cap to allow cooperative translation between the cap and the cap retainer. In this regard, translation of the cap (e.g., by a camming arrangement such as those described herein) may cause a corresponding translation of the cap retainer. Of course, translation of the cap retainer (e.g., by a geared arrangement, camming arrangement, or other configuration) may similarly cause a corresponding translation of the cap retainer.

It will further be appreciated that although only the first and second detents 951A, 951B are described here, any appropriate number or arrangement of detents may be included. Some embodiments may include one, two, three, four, five, six, or more detents to engage with a corresponding number of notches on a pod. For example, some embodiments may include two or three first detents similar to first detent 951A, and/or two or three second detents similar to second detent 951B. In some embodiments, detents may be arranged in pairs such that, for each pair, one of the first or second detents of each pair is vertically and/or horizontally offset from the other. Additionally or alternatively, each detent or pair of detents may be disposed at any appropriate location or spacing. For example, the detents may be disposed at evenly spaced intervals around an inner circumference of the movable cap retainer. In the embodiment shown, three pairs of detents 951A, 951B may be included. For each pair, a second detent 951B may be vertically offset from a corresponding first detent 951A, and each pair of detents may be disposed at evenly spaced intervals around the inner circumference of the movable cap retainer 945. However, other embodiments may include any appropriate number and/or spacing of detents, as the disclosure is not particularly limited in this regard.

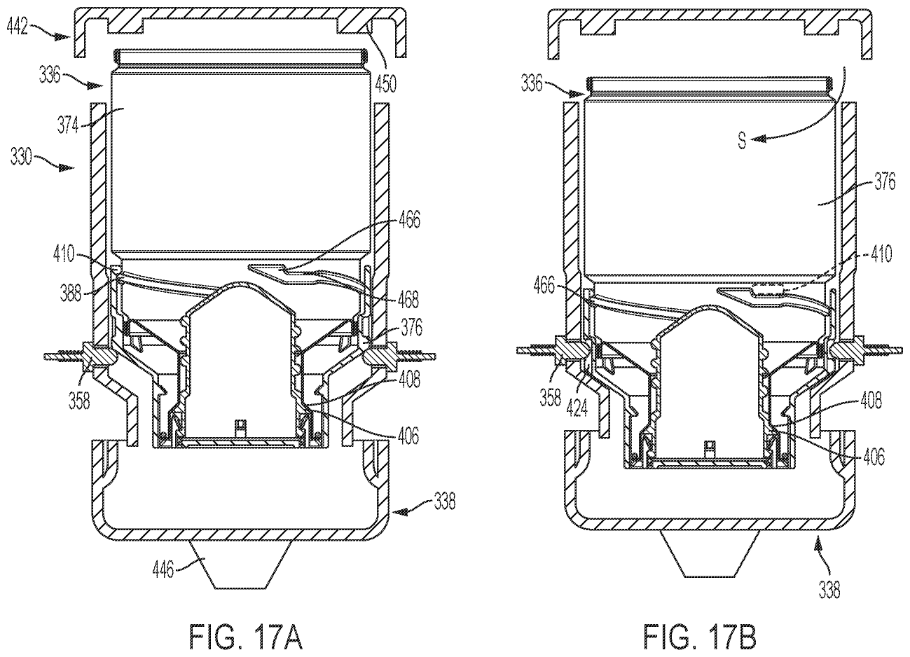

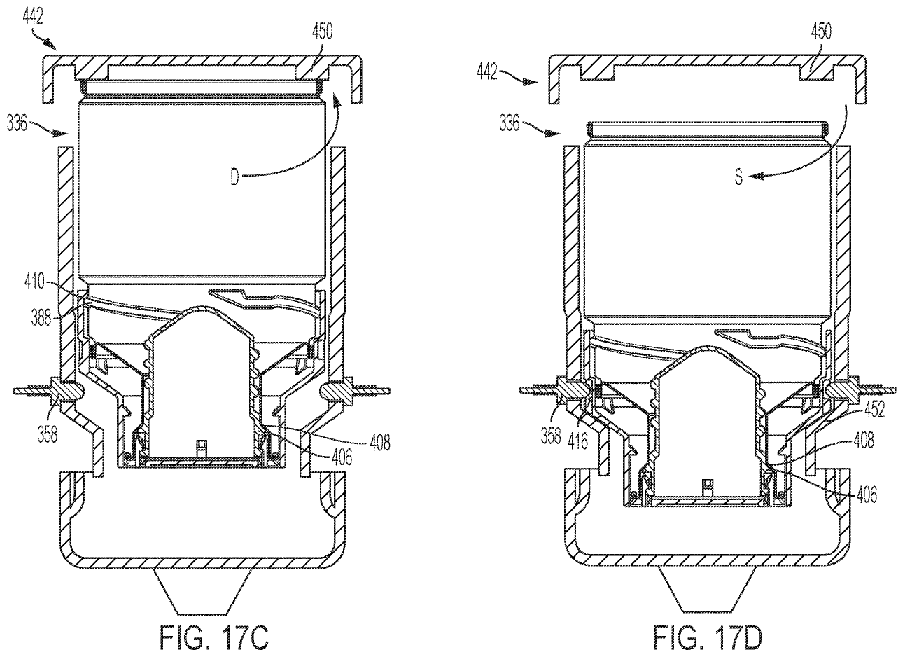

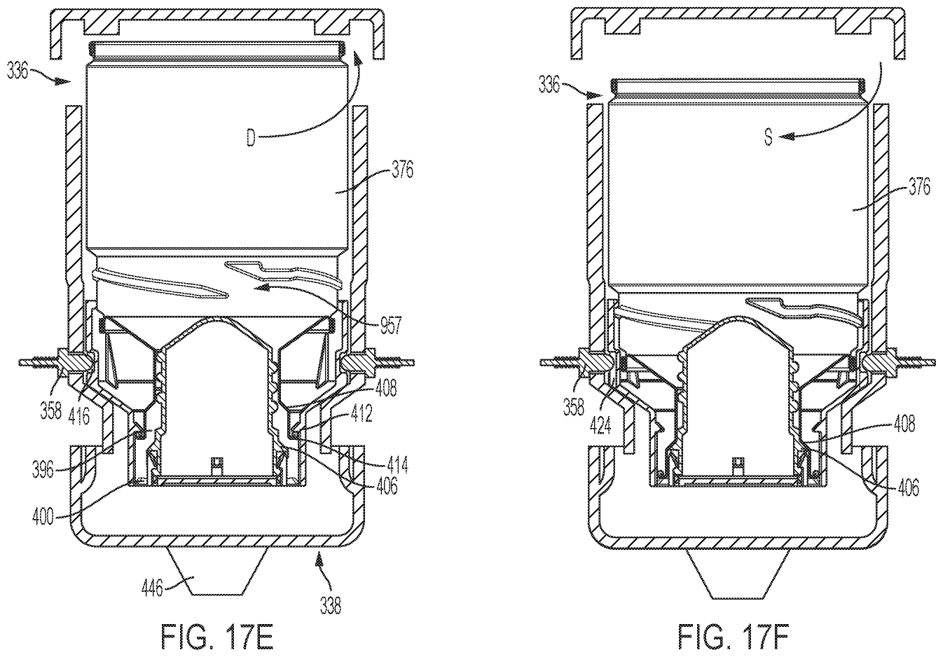

As noted above, a pod drive mechanism may be configured to impart an agitating force to a beverage additive within the pod. For example, the movable cap retainer 945 may be translatable along the rotational axis R-R of the pod receptacle 930, and the movable cap retainer 845 may be movable along the axis R-R relative to an outer sleeve 945a that supports the movable cap retainer 945 for rotation and sliding movement along the axis R-R. Downward movement of the movable cap retainer 945 relative to the outer sleeve 945a may bias the second detent 952B to move inwardly to engage with a corresponding notch on the cap. Such engagement may secure the cap relative to the movable cap retainer 945, e.g., so the cap cannot be withdrawn upwardly relative to the movable cap retainer 945. A spring 955 may cooperate with the cap retainer to bias the cap retainer in a first direction along the rotational axis, e.g., upward movement relative to the outer sleeve 945a. In some embodiments, for example in embodiments which include a camming arrangement between the cap and the reservoir as described herein (see, e.g., FIGS. 17A-17F), the spring may provide an agitating force by urging the cap back towards the reservoir, e.g., as the cap is rotated relative to the reservoir. This may occur suddenly, for example at a step in the cam path, where the cam follower may disengage from the cam at a first point and re-engage with the cam at a second point offset from the first point (see, e.g., step 957 in FIG. 17E). A suitable pod retainer may prevent rotation or other movement of the pod reservoir, e.g., a clamp may engage with the outer circumference of the pod reservoir to prevent rotation and/or movement along the axis R-R.

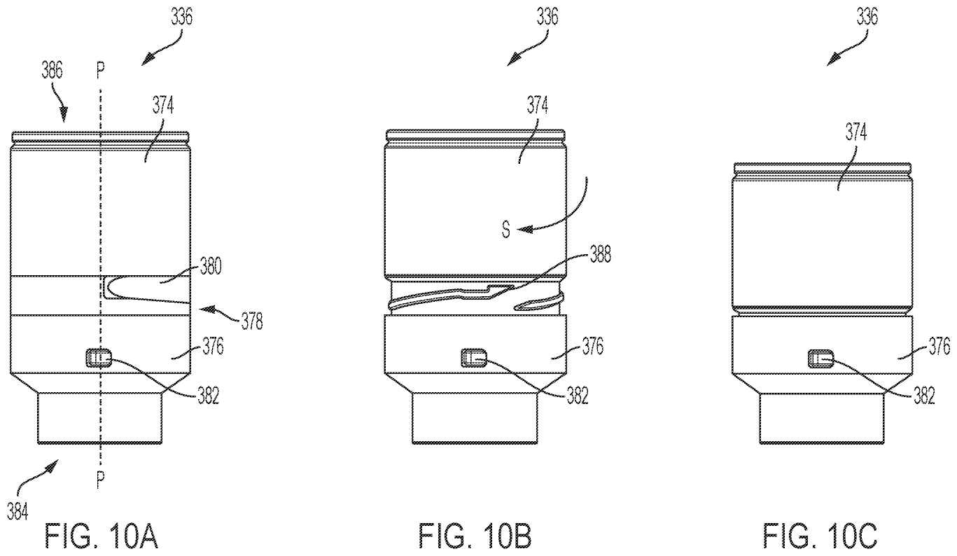

FIGS. 10A-10C depict a side view of a pod 336 according to one embodiment. In some embodiments, a pod 336 may be generally cylindrical with a longitudinal axis P-P. A proximal end portion 384 of the pod may be disposed at an opposite end of a distal end portion 386 along the longitudinal axis P-P. Additionally, in some embodiments, a pod may comprise an assembly of multiple parts. For example, in the embodiment shown, the pod 336 may include a reservoir 374 and a cap 376. The reservoir 374 may be configured to contain a beverage additive. For example, the reservoir 374 may have a wall at least partially enclosing an internal volume in which the beverage additive may be contained. The reservoir 374 may be closed at a distal end portion of the reservoir, and the reservoir may have an opening at a proximal end portion of the reservoir to allow the beverage additive to be dispensed from the internal volume. The reservoir 374 may further have one or more features to engage with or to facilitate engagement with a pod control mechanism as described above. In some embodiments, the reservoir 374 may have one or more features to engage with or to facilitate engagement with a pod drive mechanism and/or a pod retention mechanism of a pod receptacle. In the embodiment shown, an outer surface of the reservoir 374 may be configured to engage with a pod drive wheel and/or a pod retention mechanism (such as a clamp that engages with the sidewall of the reservoir) as described herein. For example, the outer surface of the reservoir may comprise a material having an appropriate surface roughness to facilitate a frictional engagement with the pod drive wheel and/or clamp. Additionally or alternatively, the material or design of the outer surface may be selected to withstand repeated frictional engagement without significant wear or degradation. In some embodiments, an outer surface may comprise a wear-resistant portion and/or a wear-resistant material to withstand repeated frictional engagement. Additionally or alternatively, the outer surface may be shaped or contoured to match a profile of a groove of the pod drive wheel as discussed above in the description of FIG. 8.

The cap 376 may be configured to cooperatively engage with the reservoir 374 or a portion of the reservoir. In some embodiments, the cap 376 may cooperatively engage with the proximal end portion of the reservoir 374 and/or with an opening at the proximal end portion of the reservoir. In some embodiments, the cap 376 may include a dispensing mechanism configured to facilitate dispensing of a beverage additive from the reservoir 374 through the cap 376. In some embodiments, a dispensing mechanism may be selectively opened or closed or may cooperate with the reservoir such that an opening of the reservoir may be selectively opened or closed. Such configurations may allow the pod to be opened or closed in order to permit or prevent dispensing of the beverage additive. In some such embodiments, that cap and the reservoir may be configured to move relative to one another in order to selectively open or close the reservoir opening. The cap 376 may further include one or more features configured to engage with or to facilitate engagement with a pod control mechanism as described above. In some embodiments, the cap 376 may have one or more features to engage with or to facilitate engagement with a pod drive mechanism and/or a pod retention mechanism of a pod receptacle. In some embodiments, a notch of the cap may be configured to engage with a detent or spring pin to retain the cap during an operation of the beverage machine. For example, in the embodiment shown, a cap 376 may include a notch 382 configured to engage with a detent to hold the cap stationary relative to the pod receptacle or to rotate the cap relative to the pod receptacle during a dispense operation.

In some embodiments, notches or other engagement features may be provided in pairs. For example, a first notch of a pair and a second notch of a pair may be disposed on opposite sides of a cap. Additionally, in some embodiments, a pair of spring pins may be disposed on opposite sides of a pod receptacle to selectively engage with the pair of notches or engagement features, the pair of spring pins cooperatively applying compressive forces to the cap to resist or prevent a movement of the cap, e.g., in rotational and/or longitudinal directions.

In some embodiments, the cap 376 and the reservoir 374 may be cooperatively engaged to allow at least one translational and/or rotational movement of one component relative to the other. In some embodiments, the cap and the reservoir may be threadably engaged to allow both translational movement and rotational movement. In the other embodiments and as shown, a camming arrangement may permit both translational movement and rotational movement. In some such embodiments, one or more cams 388 may extend around at least part of a circumference of the reservoir 374. The cap 376 may include one or more cam followers (hidden from view) which may selectively engage or disengage from a cam 388. In some arrangements, when the cap 376 is engaged with a pod retention mechanism to prevent movement of the cap and the reservoir 374 is engaged with a pod drive mechanism to rotate the reservoir, the cams 388 may cause the rotational movement of the reservoir 374 to produce a corresponding translational movement of the reservoir 374 relative to the cap 376, while the cap 376 is held stationary by the pod retention mechanism via the notches 382. For example, FIG. 10C depicts the embodiment of FIG. 10B after the reservoir 374 has been rotated in the direction indicated by arrow S (e.g., clockwise). In the embodiment shown, rotation in the direction of arrow S may cause the opening of the reservoir 374 to be closed, as will be described below. Accordingly, the pod 336 may be in a closed configuration in FIG. 10C.

In some embodiments, the pod 336 may optionally comprise a removable spacer 378. The spacer 378 may be removably disposed between the reservoir 374 and the cap 376 in order to maintain a spacing between the reservoir and the cap. As will be described, the reservoir and the cap may be configured to move in relation to one another during use. However, it may be desirable to prevent the relative movement prior to use. Accordingly, in some embodiments, the pod may be provided, manufactured, or distributed in a configuration which prevents relative movement between the reservoir and the cap. Before using a pod for the first time, a user may convert the pod to a configuration which allows relative movement between the reservoir and the cap.

For example, in some embodiments, a spacer may be included with a pod to prevent relative movement of the cap and reservoir. In some embodiments, a spacer may be disposed between the reservoir and the cap in order to prevent relative movement of the reservoir and the cap, and may be removable prior to use. As will be appreciated, a removable spacer may be inserted and secured between the reservoir and the cap by any appropriate means, and at any appropriate location. In some embodiments, the removable spacer may be snap fit into at least one of the cap or the reservoir, or may be molded as part of the cap or reservoir. In some embodiments, the removable spacer may extend around an entire circumference of the pod. In other embodiments, one or more removable spacers may be inserted at discrete locations and/or at intervals around the circumference. In the embodiment shown, the removable spacer 378 may extend around the entire circumference of the pod 336, and may include a pull tab 380 to facilitate removal of the spacer 378. For example, the pull tab 380 may be perforated or sufficiently thin along at least one edge (e.g., in its connection to the cap 376) to allow a user to easily break the pull tab along the at least one edge in order to remove the spacer 378 from the cap 376.

Additionally or alternatively, a spacer may be formed integrally with the pod, for example as a portion of a cap and/or a portion of a reservoir, such that the spacer is not removable. For example, in some embodiments, a cap may include a spacer comprising a compressible or otherwise movable interference fitting around at least a portion of a circumference of the cap. The interference fitting may include a lip which may contact a circumferential edge of the reservoir and prevent movement of a portion of the cap and the reservoir unless and until the lip is moved to disengage from the reservoir. For example, the interaction or interference between the lip and the edge may prevent relative movement the reservoir until the interference fitting is compressed or squeezed to urge the lip off of the circumferential edge, thereby relieving the interference to allow relative movement between the cap and the reservoir.

The dispensing and closing functions and related features of a pod and pod receptacle according to certain embodiments will now be described with reference to FIGS. 11A-17F. As can be seen from the cross-sectional view of FIG. 11A, the reservoir 374 may have an internal volume 398 configured to contain a beverage additive 390. In some embodiments the beverage additive 390 may be in a powder form, although it will be appreciated that in other embodiments, the additive may be provided in a liquid form, as the disclosure is not limited in this regard. As can further be seen from the cross-sectional view, the reservoir 374 may have a distal end portion 392 and a proximal end portion 394, corresponding to the distal and proximal end portions of the pod 336 described above. In some embodiments, the distal end portion 392 of the reservoir 374 may be closed such that the beverage additive 390 may be contained by the distal end portion. In various embodiments, the distal end portion 392 may be closed by any appropriate means, including by forming the reservoir as a single piece such that a wall of the reservoir may be continuous from the proximal end portion to the distal end portion. In embodiments in which the reservoir is assembled from multiple pieces, an endplate may be sealed to a wall of the reservoir by any appropriate means, including crimping, snap fitting, press fitting, friction sealing, threading, attaching with fasteners, welding, or any other appropriate means.

In some embodiments, the proximal end portion 394 may include an opening 396 to allow the beverage additive 390 to be dispensed from the internal volume 398. In some embodiments, following the longitudinal axis P-P in the proximal direction (i.e., from the distal end portion 392 to the proximal end portion 394), the proximal end portion 394 may taper inwardly to reduce a diameter of the reservoir. In some embodiments, continuing to follow in the proximal direction, the proximal end portion may taper back outwardly to increase a diameter near the opening 396. Thus, the proximal end of the reservoir can have an hourglass shape with tapered portions leading to and away from a narrowest portion of the hourglass shape.

In some embodiments, the cap 376 may be sized and shaped to accommodate at least a portion of the reservoir 374 or a proximal end portion 394 of the reservoir. Additionally, the cap 376 may include at least one pod outlet 400 (e.g., one or more openings or holes) at a proximal end of the cap to allow the beverage additive 390 to be dispensed from the reservoir 374 through the cap 376. As noted above, the cap may further include a dispensing mechanism configured to facilitate dispensing of the beverage additive. For example, in the embodiment shown, the cap 376 may include an auger 402. The auger 402 may be at least partially disposed within the proximal end 394 of the reservoir and/or within the opening 396 of the reservoir. The auger 402 can extend into the internal volume 398 of the reservoir, and may include a thread 404 that extends around an outer surface of the auger. The thread 404 may help convey the beverage additive 390 through the opening 396 and to the pod outlet 400, e.g., when the auger 402 is rotated relative to the reservoir 374. In some embodiments, the auger 402 need not include a thread or helical groove or protrusion to aid in moving additive through the opening, and instead may have a smooth cylindrical shape. In some cases, most or all of the auger 402 can be eliminated, e.g., only portions retained to aid in closing the opening of the reservoir.

In some embodiments, when a pod is in a closed configuration, a cap or a dispensing mechanism thereof may cooperate with the reservoir to close an opening of the reservoir. For example, the auger may cooperate with the reservoir to close an opening of the reservoir when the pod is in the closed configuration. For example, in the closed configuration shown in FIG. 11A, a shoulder 406 of the auger 402 may cooperate with a sealing surface 408 of the reservoir 374 to prevent the beverage additive from being dispensed through the opening. In some cases, the sealing surface 408 can be formed by a portion of the reservoir 374 that tapers downwardly and outwardly relative to the longitudinal axis P-P. In some embodiments, a cam follower 410 may be engaged with a cam 388 to move the cap 374 distally relative to the reservoir 374 and thereby press the shoulder 406 against the sealing surface 408. Thus, in some embodiments, a sealing surface of the reservoir may be sized and shaped to form a seal against a dispensing mechanism when the sealing surface is pressed against the dispensing mechanism. For example, in some embodiments, the sealing surface 408 may be sized and shaped to form a seal against the shoulder 406 of the auger 402 when the sealing surface 408 is pressed against the shoulder 406. In some cases, the sealing surface may be pressed against the shoulder by an engagement between a cam 388 of the reservoir and a cam follower 410 of the cap 376. That is, when the cap 374 is rotated relative to the reservoir 374, the cam follower 410 can ride along a respective cam 388 and urge the cap 374 to move upwardly or distally relative to the reservoir 374 and press the shoulder 406 against the sealing surface 408 of the reservoir 374. Although embodiments have been described which use camming arrangements to move the cap relative to the reservoir, it will be appreciated that in some embodiments, a sealing surface or other portion of a reservoir may form a seal against a cap or other dispensing mechanism by virtue of any appropriate mechanism, including a threaded engagement between the cap and the reservoir, an actuator applying a compressive force on the cap and/or the reservoir, or any other appropriate apparatus.

In some embodiments, when a pod is in a closed configuration, rotation of a reservoir and a cap of the pod relative to each other may open an opening of the pod to transition the pod into a dispensing configuration. When a pod is in a dispensing configuration, the opening of the reservoir may be open to allow the beverage additive to be dispensed from the reservoir. In some embodiments, a cap or a dispensing mechanism thereof may be spaced apart from a portion of the reservoir to open the pod. For example, in the dispensing configuration shown in FIG. 11B, the sealing surface 408 of the reservoir may be spaced apart from the shoulder 406 of the auger 402, such that a beverage additive 390 may be conveyed through the opening 396 by the auger. In the dispensing configuration, the cam follower 410 of the cap may be disengaged from the cam 388 of the reservoir. However, in some embodiments a cap and a reservoir may remain cooperatively engaged when a cam follower of the cap is disengaged from a cam of a reservoir. For example, in some embodiments, a lip 412 of the cap may be engaged with a foot 414 of the reservoir to prevent the cap and the reservoir from disengaging. In this configuration, when a drive mechanism of a pod receptacle (e.g., a pod drive wheel as described above) rotates the reservoir or cap in the dispense direction indicated by arrow D, the reservoir or cap may rotate about an axis perpendicular to a plane at the engagement between the lip 412 and the foot 414. It will be appreciated that a corresponding movement of the reservoir in a longitudinal direction relative to the cap which may otherwise result from an angled orientation of the drive mechanism or drive wheel may be limited by the engagement between the lip and the foot. It will further be appreciated that the disengagement of the cam follower 410 from the cam 388 may prevent a corresponding translation which would otherwise result. Accordingly, the engagement between the lip 412 and the foot 414 may allow the reservoir to rotate substantially in-plane with the lip 412.

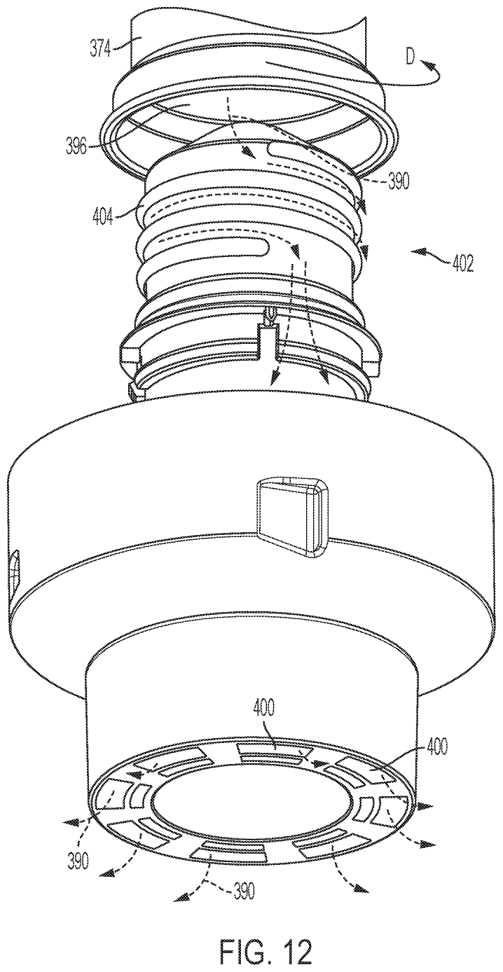

With reference to FIG. 12, it will be appreciated that the auger 402 may convey a beverage additive through an opening 396 of a pod 336 by a relative rotation between the auger 402 and the reservoir 374. For example, when the reservoir 374 is rotated in the dispense direction D relative to the cap 376, the beverage additive 390 may be conveyed by the thread 404 of the auger 402. After the beverage additive 390 has been conveyed to a proximal end of the thread 404, the additive may flow through one or more pod outlets 400 formed in the cap 376.

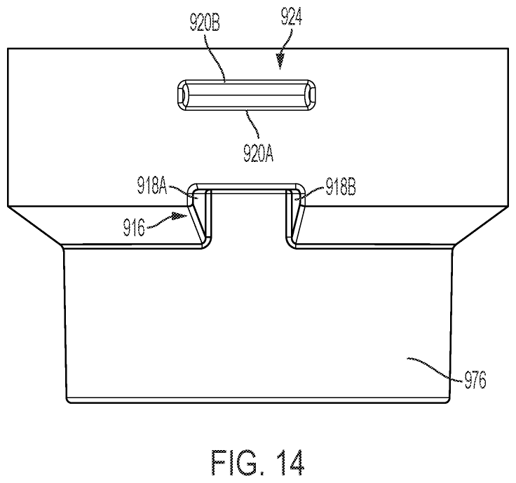

In some embodiments and as shown in FIGS. 13-14, a pod may include multiple engagement features to engage with or to facilitate engagement with one or more pod retention mechanisms and/or pod drive mechanisms of a pod receptacle. In some embodiments, the pod may include different types of engagement features or no engagement features at all. For example, in the embodiment of FIG. 13, a pod 336 may include two or more notches to engage with or to facilitate engagement with one or more detents or spring pins of a pod receptacle, including a first notch and a second notch. In the embodiment of FIG. 13, the first notch may be a dispense notch 416, and the second notch may be a reclose notch 424. Each notch may be formed as an indent or cut-out in an outer surface of the cap 376, although it will be appreciated that in other embodiments, a notch or other engagement feature may additionally or alternatively be provided on a reservoir of a pod or on any other appropriate portion or location of a pod.

In some embodiments, each notch may comprise one or more ridges configured to prevent a movement of the pod or a portion thereof in at least one direction by engaging with a pod retention mechanism. For example, in the embodiment of FIG. 13, the dispense notch 416 may comprise a first longitudinal ridge 418 configured to prevent a rotational movement of the cap 376 by engaging with a spring pin 358. The first longitudinal ridge 418 may run in a longitudinal direction of the pod 336 along a side of the dispense notch 416 and may be formed as an edge against which a spring pin 358 may be pressed when the pod 336 is rotated and/or translated in a dispense direction indicated by arrow D. The engagement of the spring pin 358 with the first longitudinal ridge 418 may prevent the cap 376 from rotating further in the dispense direction D when the spring pin is engaged with the dispense notch 416.

In some embodiments, the dispense notch 416 may further comprise a first circumferential ridge 420 and a second circumferential ridge 422. Each circumferential ridge may be configured to prevent a translational movement of the cap 376 by engaging with a spring pin 358. Each circumferential ridge may run in a circumferential direction of the pod 336 along a side of the dispense notch 416 and may be formed as an edge against which a spring pin 358 may be pressed when the pod 336 is moved vertically. The first circumferential ridge 420 may be formed as an edge against which the spring pin 358 may be pressed when the pod 336 is rotated and/or translated in the dispense direction D. The engagement of the spring pin 358 with the first circumferential ridge 420 may prevent the cap 376 from translating further in the dispense direction D. The second circumferential ridge 422 may be formed as an edge against which the spring pin 358 may be pressed when the pod 336 is rotated and/or translated in the close direction indicated by arrow S. The engagement of the spring pin 358 with the second circumferential ridge 422 may prevent the cap 376 from translating further in the close direction S when the spring pin is engaged with the dispense notch 416.

Further, in the embodiment of FIG. 13, the reclose notch 424 may comprise a second longitudinal ridge 426 configured to prevent a rotational movement of the cap 376 by engaging with a spring pin 358. The second longitudinal ridge 426 may run in a longitudinal direction of the pod 336 along a side of the reclose notch 424 and may be formed as an edge against which a spring pin 358 may be pressed when the pod 336 is rotated and/or translated in the close direction S. The engagement of the spring pin 358 with the second longitudinal ridge 426 may prevent the cap 376 from rotating further in the close direction S when the spring pin is engaged with the reclose notch 424.

In some embodiments, the reclose notch 424 may further comprise a third circumferential ridge 428 configured to prevent a translational movement of the cap 376 by engaging with a spring pin 358. The third circumferential ridge 428 may run in a circumferential direction of the pod 336 along a side of the reclose notch 424 and may be formed as an edge against which a spring pin 358 may be pressed when the pod 336 is rotated in the close direction S. The engagement of the spring pin 358 with the third circumferential ridge 428 may prevent the cap 376 from translating further in the close direction S.

In view of the above, it will be appreciated that FIG. 13 depicts the directions in which a spring pin 358 may be free to move relative to the cap 376 when the spring pin 358 is engaged with either the dispense notch 416 or the reclose notch 424. Unconstrained directions of relative movement are illustrated by an arrow extending from the depicted spring pin 358, while constrained directions are illustrated by a “T” indicator. It will be appreciated that FIG. 12 depicts relative movement for ease of illustration, and that in some embodiments, the spring pin 358 may be stationary while the pod 336 and/or the cap 376 may be moved in corresponding directions to achieve the relative movement depicted.

It will further be appreciated that the selective engagement between the cap 376 and the reservoir 374 (e.g., a threaded engagement or the camming arrangement described above) may allow the reservoir 374 to move relative to the cap 376 while the cap 376 is retained by the engagement of the spring pin 358 with either the dispense notch 416 or the reclose notch 424. For example, the reservoir 374 may be engaged with and moved by a pod drive mechanism, (e.g., the pod drive wheel described above) while the cap is engaged with and retained by a pod retention mechanism (e.g., a spring pin). The relative movement may open an opening of the pod 336 to allow a beverage additive contained in the reservoir to be dispensed from the pod, as described herein.

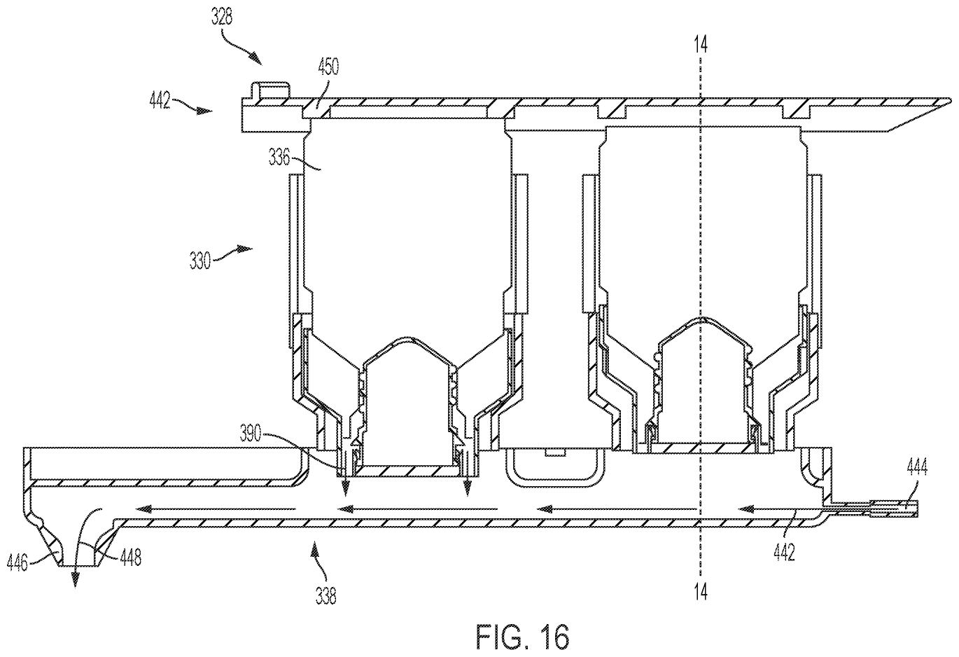

In operation, a pod 336 according to the embodiment of FIG. 13 may be inserted into a pod receptacle having a pod drive wheel as described above and at least one spring pin 358. In some cases, a notch 354 of the drive wheel 340 can be positioned to aid in easier insertion of the pod into the pod receptacle. The pod drive wheel may rotate and/or translate the pod 336 in the close direction S until the reclose notch 424 engages with a spring pin 358. As an example, when the reclose notch 424 is aligned with a spring pin 358, the pod 336 may move downwardly such that the pin 358 is received into the notch 424. When the reclose notch 424 is engaged with the spring pin 358, the pod drive wheel may rotate and/or translate the pod 336 in the dispense direction D. However, in some embodiments as described above, the pod drive wheel may be angled or the pod receptacle and/or pod may be otherwise configured to produce a translation in a longitudinal direction in addition to a rotation caused by the pod drive wheel. Accordingly, in some embodiments, a pod 336 which is rotated in the dispense direction D may be translated a sufficient distance in the longitudinal direction that the spring pin 358 may pass alongside the dispense notch 418 without the dispense notch 418 being engaged by the spring pin 358. Therefore, in some embodiments, a beverage machine or a pod receptacle thereof may include a lid configured to limit or prevent a longitudinal translation of a pod when the pod is disposed within a pod receptacle, as will be described with reference to FIG. 16.

FIG. 14 depicts another embodiment of a cap 976 which includes a first notch 916 and a second notch 924. As noted above with respect to FIG. 9, each of the first and second notches 916, 924 may be configured to engage with a corresponding detent of a pod drive mechanism or a portion of a pod drive mechanism (e.g., the detents 951A, 951B of the movable cap retainer 945) to allow cooperative movement between the cap and the cap retainer as described above. For example, the first notch may include a first longitudinal ridge 918A and a second longitudinal ridge 918B configured to resist relative rotation between the cap and the cap retainer in a first and a second rotational direction, respectively. Additionally or alternatively, the second notch 924 may include a first circumferential ridge 920A and a second circumferential ridge 920B configured to resist relative translation between the cap and the cap retainer in a first and second translational direction (e.g., up and down in FIG. 14), respectively. By resisting relative movement between the cap and the cap retainer, cooperation between the notches and the detents may facilitate cooperative movement between the cap and the cap retainer, e.g., allowing the cap retainer to rotate the cap relative to the reservoir. Otherwise, the cap in FIG. 14 may include any suitable features or combinations of features described herein, such as an auger, etc.

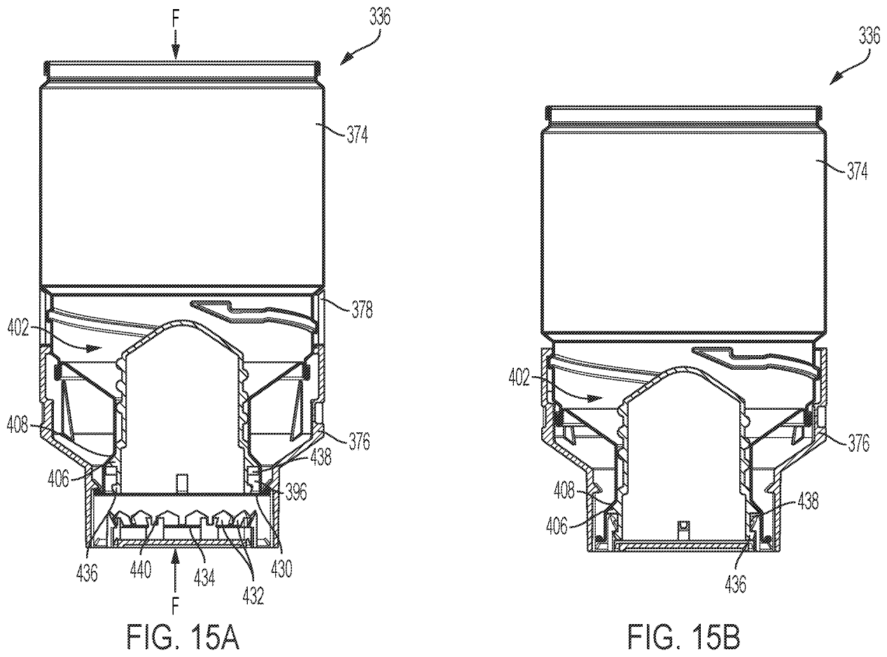

In some applications, a pod may be stored in an unused state for extended periods after manufacture but prior to use. Accordingly, it may be desirable to keep the pod in a closed configuration in order to prevent the beverage additive from dispensing prematurely, to maintain freshness of the beverage additive, and/or to prolong a shelf life of the beverage additive. In some embodiments, a cover may be included to ensure an opening of the pod remains closed prior to use. In some embodiments, a cover may comprise a lid, a membrane, a foil, a wrapper, or any other appropriate covering in or on the pod to ensure the opening remains sealed until it becomes desirable for the opening to be unsealed (e.g., immediately prior to use). In some embodiments, a cover may comprise a membrane disposed at the proximal end portion of the reservoir and may provide a barrier to moisture, gasses or other environmental conditions, e.g., so an additive can be stored in the pod for months or years prior to use. For example, in the embodiment of FIGS. 15A-15B, a membrane 430 may be disposed across the opening 396. In this configuration, the auger 402, if provided, may be located within the sealed internal space 398.

However, in some embodiments which include a cover such as a membrane, a foil, or a wrapper, it may be possible for the cover to tear, puncture, rupture, or otherwise break before the pod is intended to be used. Therefore, it may be desirable to provide an additional seal in order to prevent beverage additive from being dispensed if the cover is broken prematurely. Accordingly, in some embodiments, a cover may press a first portion of a pod against a second portion of the pod to form an internal seal on an internal side of the cover, the internal seal being separate from a seal provided by the cover. In some embodiments, the cover may press a sealing portion of a cap and/or a portion of a dispensing mechanism against a portion of a reservoir to form the internal seal. In some embodiments, the sealing portion of the cap or dispensing mechanism may be disengaged from the cap until the cover is broken. In some embodiments, an engagement between the sealing portion and the cap may break the cover.

FIGS. 15A-15B show an internal seal formed by a cover and a portion of a cap according to one embodiment. In FIG. 15A, the pod 336 may be provided in an unused state. In some embodiments, a pod in an unused state may include both a cover forming a seal at an opening of a reservoir and a sealing portion forming an internal seal with the reservoir on an internal side of the cover, as described above. In some embodiments, a cover may comprise a membrane 430. The membrane 430 may be disposed across an opening 396 of a reservoir 374 to prevent a beverage additive from being dispensed through the opening 396 until the membrane 430 is removed or pierced. An auger 402, substantially as described above with respect to FIGS. 11A-11B, may be disposed on an internal side of the membrane 430, such that the auger 402 may extend into the opening 396. A shoulder 406 of the auger may form a seal against a sealing surface 408 of the reservoir, as described above.

The cap 376 may include one or more piercing features configured to tear, puncture, rupture, pierce, or otherwise break a cover of a pod. For example, the cap may include a plurality of crenellations 432 configured to pierce and/or tear the membrane 430. In some embodiments, the crenellations 432 may be disposed in a circular pattern. At least one of the crenellations 432 may be configured to tear, puncture, rupture, or otherwise break the membrane 430. For example, in the embodiment shown, each of the crenellations is pointed. Other embodiments may include any appropriate number of pointed crenellations, as it will be appreciated that even a single puncture may be propagated through a membrane to break the entire membrane. In some embodiments, a piercing feature may additionally be configured to engage with a sealing portion of a cap to prevent a rotation and/or a translation of the sealing portion relative to the cap. For example, in the embodiment shown, the plurality of crenellations 432 may be configured to engage with the auger 402 when the membrane 430 is pierced. For example, the crenellations 432 may be formed with a rim 434 which may be sized and shaped to form a snap fit with a corresponding ledge 436 on the auger 402 when the crenellations 432 pierce the membrane 430, as shown in FIG. 15B. Movement of the cap 374 to cause the crenellations 432 to pierce the membrane 430 may be caused by rotating the cap 374 relative to the reservoir 374, e.g., rotation of the cap 374 may cause the cam follower 410 to ride upwardly on a corresponding cam 388, causing the cap 374 to move upwardly or distally relative to the reservoir 374.

As described above, a movement of the reservoir 374 relative to the cap 376 in a longitudinal direction may be limited or prevented by the engagement of a lip 412 of the cap with a foot 414 of the reservoir. However, it will be appreciated that this engagement limits the longitudinal movement in only one direction, and that a movement in the opposite direction may bring the membrane 430 into contact with the crenellations 432. Therefore, it may be desirable to limit or prevent the movement of the reservoir relative to the cap in the opposite direction, such that the membrane 430 may be spaced apart from the crenellations 432 until the pod 336 is to be used. Accordingly, in some embodiments, a removable spacer 378, as described above, may be included to prevent or limit the movement of the reservoir relative to cap, thereby maintaining a space between the membrane 430 and the crenellations 432 until the removable spacer 378 is removed.

Additionally, as noted above with reference to FIG. 12, an auger 402 may convey a beverage additive through an opening 396 of a pod 336 by a relative rotation between the auger 402 and the reservoir 374. In various embodiments, such relative rotation may be achieved by rotating both components at different rates or in different directions, by holding the reservoir still and rotating the auger, and/or by holding the auger still and rotating the reservoir. In the embodiment shown, the auger 402 may be held still and the reservoir 374 may be rotated by a pod drive mechanism, such as the pod drive wheel described above. In embodiments where the auger is disengaged from the cap when the pod is in an unused state, the pod may include one or more anti-rotation features on at least one of the auger and the cap. In some embodiments, anti-rotation features of both the auger and the cap may cooperate to limit or prevent a rotation of the auger relative to the cap. For example, as can be seen in FIG. 15A, the auger may include one or more anti-rotation tabs 438 and the cap may include one or more embrasures 440 disposed between the crenellations 432. When the crenellations 432 have broken the membrane 430 and/or when the rim 434 has formed the snap fit with the ledge 436, an anti-rotation tab 438 may cooperate with an embrasure 440 to limit or prevent rotation of the auger 402 relative to the cap 376 while the reservoir 374 may rotate relative to the auger 402 and/or the cap 376. In some embodiments, an anti-rotation tab 438 may be a narrow radial member extending from the ledge 406 toward a pod outlet or toward the crenellations 432. Additionally, an embrasure 440 may be a gap between adjacent crenellations. In some embodiments, an embrasure 440 may be at least partially tapered to be wider at a distal end and narrower at a proximal end, such that an anti-rotation tab 438 may be guided into the embrasure 440 by the narrowing gap.

In operation, a user may remove the removable spacer 378 and apply a compressive force F to the pod 336. The compressive force F may be applied by hand, e.g., a user pressing the reservoir 374 and cap 376 towards each other, or by the pod drive mechanism rotating the reservoir 374 and cap 376 relative to each other, which causes the cap 376 and reservoir 374 to move toward each other by way of the cam follower 410 riding along a corresponding cam 388. The force F may drive the reservoir 374 towards the cap 376, thereby driving the membrane 430 towards the crenellations 432. The force F may drive the crenellations 432 through the membrane 430 and into the ledge 436. As the crenellations 432 slide past the ledge 436, an anti-rotation tab 438 may be inserted into an embrasure 440 to limit or prevent a rotation of the auger 402 relative to the cap 376. Additionally, the rim 434 may slide past the widest portion of the ledge 436 and create a snap fit between the rim 434 and the ledge 436 to prevent a translation of the auger 402 relative to the cap 376. Additionally, as the reservoir and the cap are driven together by the compressive force F, a cam follower 410 may engage with a cam 388 substantially as described above to facilitate or guide a rotation of the reservoir with respect to the cap. When the rim 434 and ledge 436 have formed the snap fit, and the anti-rotation tab 438 has been inserted into the embrasure 440, the pod 336 may be in a primed state as shown in FIG. 15B.

When a pod is in a primed state, it may be prepared to be loaded into a beverage machine and/or used to dispense additive. For example, in some embodiments, a pod in a primed state may have an internal seal which may be closed to prevent a beverage additive from being dispensed, e.g., a shoulder 406 of the auger 402 can engage with a sealing surface 408 of the reservoir 374 to close the reservoir opening. As shown in FIG. 16 and as described above, a beverage machine may include a beverage forming module 328. According to some embodiments, a beverage forming module 328 may include a mixing area 338, a lid 442, and at least one pod receptacle 330, as described above. In some embodiments, each pod receptacle 330 may be disposed between the lid 442 and the mixing area 338, and may be configured to dispense a beverage additive 390 from a pod 336 into the mixing area. The mixing area 338 may be configured to mix liquid from the liquid supply and beverage additive to form a beverage. In some embodiments, the mixing area 338 may include an inlet 444 for receiving water or other liquid 442 from a liquid supply, and an outlet 446 for dispensing a beverage 448. In some embodiments, the outlet 446 of the mixing area may be a system outlet of the beverage machine configured to dispense the beverage. In other embodiments, the outlet 446 may provide the beverage 448 to a dispensing module or a dispensing outlet. Additionally, in some embodiments, the beverage 448 may comprise the liquid 442 and, optionally, the beverage additive 390. It will be appreciated that, in various applications, a beverage machine may provide water alone or the beverage machine may provide a beverage additive mixed into the water or other liquid. The lid 442 may cover the beverage forming module and/or the pod receptacles 330. In some embodiments, the lid 442 may additionally limit or prevent a translation of a pod 336 within a pod receptacle 330. For example, the lid 442 may limit or prevent a translation of a pod if a pod retention mechanism of a pod receptacle (e.g., a spring pin or detent as described above) is disengaged from an engagement feature of a pod (e.g., a notch or ridge; see FIG. 13), particularly when an engagement between the pod retention mechanism and the engagement feature would limit, prevent, or resist the translation. In some embodiments, the lid 442 may optionally include one or more pod stops 450 to facilitate limiting or preventing the translation of a pod. A pod stop 450 may be a protrusion or a thickened area of the lid 442 which may define a spacing between the lid 442 and a pod receptacle 330. In other embodiments, the lid itself may define the spacing between the lid and a pod receptacle. In various embodiments or applications, the lid 442 may limit or prevent the translation of a pod 336 during a loading process, an unloading process, or during any other appropriate time or operation.

FIGS. 17A-17F depict a pod loading process and a dispensing process according to some embodiments. In some embodiments, during a loading process, a pod 336 may be provided in a pod receptacle, e.g., in a state in which the pod opening is closed to prevent a beverage additive from being dispensed. In some embodiments, the pod may be provided in the pod receptacle in a primed state, e.g., in which a cover or membrane of the pod may have been removed or broken by piercing the membrane with a portion of the cap. In the primed state, the pod opening may be closed by a shoulder 406 of an auger contacting a sealing surface 408 of the reservoir as described above. Further, in the primed state, a cam follower 410 of the cap 376 may be engaged with a cam 388 of the reservoir 376 to maintain engagement between the shoulder 406 and the sealing surface 408. However, the pod need not be in a primed state, but rather in a state in which the cover or membrane seals the reservoir opening closed. In FIG. 17A, the pod 336 may be inserted into a pod receptacle 330 of a beverage machine and a lid 442 may be moved into place to cover the pod 336 within in the pod receptacle 330. In various embodiments, the lid 442 may be lowered into place, the lid 442 may slide into place, or the lid 442 may be actuated into place in any appropriate manner or by any appropriate mechanism.

In some embodiments, e.g., to facilitate insertion or removal of a pod, a pod retention mechanism may be configured to support the pod without resisting movement of the cap relative to the reservoir. In some embodiments, the pod 336 may rest on one or more pod retention mechanisms within the pod receptacle 330. For example, as shown in FIG. 17A, the pod 336 may be supported by one or more spring pins 358. The spring pins 358 may cooperate or engage with a tapered portion of the pod cap 376 to prevent the pod 336 from inserting further downwardly into the pod receptacle 330. This support may help expose an upper part of the pod so a user can grasp the pod for removal from the pod receptacle 330. In some embodiments, the pod receptacle may include a pod drive mechanism, such as a pod drive wheel as described above (not shown). The pod drive wheel may be configured to rotate and translate the reservoir 374 and/or cap 376. For example, as described above, the pod drive wheel may rotate about an axis which is angled with respect to a longitudinal axis of the pod or a longitudinal axis of the pod receptacle, such that when the pod drive wheel is frictionally engaged with the pod, a rotation of the pod drive wheel may produce a corresponding rotation of the pod about the longitudinal axis of the pod as well as a corresponding translation along the longitudinal axis.

Accordingly, as shown in FIG. 17B, when the pod 336 is at rest on the spring pins 358, the pod drive wheel may rotate and translate the pod in a close direction S in order to engage the spring pins 358 with one or more reclose notches 424 of the cap. Engagement of the spring pins 358 with a reclose notch 424 may allow the pod to move downwardly into the pod receptacle. With the cap 374 engaged by the spring pins 358, the reservoir 374 can be further rotated relative to the cap 376, e.g., to move the cap 376 to a closed position relative to the reservoir 374. This can cause the cap 376 to pierce a cover or membrane and engage the cap 376 with an auger 402, e.g., by passing crenellations through the membrane to engage with the auger. In some embodiments, the pod may be provided into the pod receptacle in a closed position with the cap 376 engaged with an auger 402 or otherwise configured to close the pod opening.

As described with reference to FIG. 13, a reclose notch 424 may include a longitudinal ridge to prevent further rotation of the cap 376 in the close direction S when the reclose notch 424 is engaged with a spring pin 358. This can permit the pod drive wheel to rotate the reservoir relative to the cap in the close direction S, e.g., to pierce a cover or membrane and engage the cap with an auger in the internal space of the reservoir. Additionally, a cam follower 410 may be engaged with a cam 388 to maintain a rotational position of the reservoir 374 relative to the cap 376 when the reservoir is rotated in the close direction S. For example, a cam follower 410 may be engaged with a cam limiter 466 (e.g., a hook) of a cam 388, which may be located at a distal end of the cam. A cam limiter may be configured to cooperate with a cam follower to prevent rotation in one direction, and may additionally be configured to allow rotation in a second direction opposite the first direction. For example, the cam follower 466 may comprise a seat 468 in which the cam follower 410 may be seated when the cap 376 and reservoir 374 are in a closed position. The seat 468 may comprise a circumferential edge and at least one longitudinal edge, the circumferential edge running in a circumferential direction of the reservoir and the longitudinal edge running in a longitudinal direction of the reservoir. The longitudinal edge may prevent the cam follower 410 from continuing along the cam 388 in a first rotational direction while allowing the cam follower to pass along the cam in a second rotational direction, thereby preventing rotation of the reservoir in the first direction and allowing rotation in the second direction. In some embodiments, rotation of the pod in the close direction S may rotate the reservoir and the cap together when the cam follower 410 is engaged with the cam limiter 466, e.g., when a spring pin 358 is not engaged with a reclose notch 424. With a spring pin 358 engaged with a reclose notch 424 and/or the cam follower 410 engaged with the cam limiter 466, a controller of the machine can detect that the pod is in the pod receptacle and is in the closed and/or primed state. For example, in such a condition, when the pod drive wheel attempts to rotate the pod, the reservoir 374 may not be able to rotate further relative to the cap 376 in the reclose direction S and the spring pin 358 may prevent rotation of the pod in the reclose direction S. This may cause the pod drive wheel and motor to experience a high load, which can be detected by the controller and indicate the pod is in a closed and/or primed state. In some embodiments, the controller can use information from a sensor 377 to detect rotation of the pod or portions of the pod (or the lack of rotation or other movement) to detect that the pod is in the primed and/or closed state.

As shown in FIG. 17C, even when the spring pins 358 are engaged with the reclose notches 424, the reservoir may be rotated in the dispense direction D. For example, once the controller detects that a pod is in a closed and/or primed state and the spring pin(s) 358 are engaged with a reclose notch 424, the controller can know that the pod is in a defined rotational position in the pod receptacle. From this position, the controller may rotate the pod in the dispense direction D, e.g., to engage the spring pins 358 with one or more dispense notches 416, as described with reference to FIG. 13. However, in some embodiments and as shown in FIG. 17C, a geometry of the cap 376 and an angled disposition of a pod drive wheel (see FIG. 7) may cause the spring pins 358 to pass by the dispense notches 416 without engaging the dispense notches, e.g., because the pod may move upwardly under the driving force of the pod drive wheel. In some such embodiments, the reservoir may be rotated further in the dispense direction D, until the reservoir 374 contacts or references against the lid 442 or a pod stop 450 of the lid. In some embodiments, the lid 442 may be configured to allow the reservoir to be rotated into the lid without displacing the lid 442, i.e., the lid 442 can limit the upward travel of the pod. For example, in some embodiments, the lid 442 may be snapped, latched, or otherwise secured in place to withstand a force transmitted to the lid by the rotation and translation of the pod in the dispense direction D by a pod drive mechanism. Rotational position of the pod can be detected by the controller based on a number of rotations of the pod drive wheel, a sensor 377 detecting a rotational position of the pod, and/or other sensor information.

In some embodiments, when the pod 336 is referenced against the lid 442, an orientation of the pod 336 may be detected, determined, and/or controlled by a controller of the beverage machine in conjunction with a sensor as described with reference to FIGS. 7-8. As previously described, the sensor may detect one or more visual indicia or orientation marker configured to convey information about a rotational position or orientation of the pod in the pod receptacle 330. For example, the sensor may detect a radial pattern on a top and/or side surface of the pod and/or a position marking on a side surface of the pod in order to determine an orientation of the pod 336 within the pod receptacle 330. Further, the controller may control the orientation of the pod 336 by actuating the pod drive wheel to rotate the pod until the pod is in a desired orientation. For example, in some embodiments, the pod may be rotated until it is in a pre-dispense position. From a pre-dispense position, a pod may be rotated in the close direction S and translated downwardly a predetermined amount to engage one or more spring pins 358 with one or more dispense notches 416, as shown in FIG. 17D.

In the position shown in FIG. 17D, the spring pins 358 may be engaged with the dispense notches 416, as described with reference to FIG. 13. This engagement may prevent a rotation of the cap 376 when the reservoir 374 is rotated in the dispense direction D. For example, a first and second circumferential ridge of a dispense notch 416 may prevent translations of the cap along the longitudinal direction as described above, and a longitudinal ridge may prevent rotation of the cap 376 in the dispense direction D. Accordingly, when the reservoir 374 is rotated in the dispense direction D, the reservoir 374 may be moved relative to the cap 376, as shown in FIG. 17E. For example, the cam limiter 466 may disengage from the cam follower 410, and the cam 388 may cooperate with the cam follower 410 to guide the rotation and translation of the reservoir 374 with respect to the cap 376, e.g., so the cap 376 moves away from the reservoir 374. The movement of the reservoir relative to the cap may disengage the sealing surface 408 of the reservoir from the shoulder 406 of the auger, thereby opening the opening 396 of the reservoir as shown in FIG. 17E. In the configuration of FIG. 17E, when the reservoir 374 is rotated further in the dispense direction D, the reservoir may rotate in a plane established by an engagement between a lip 412 of the cap and a foot 414 of the reservoir, as described above with reference to FIG. 11B.

This rotation of the reservoir 374 relative to the cap 376 may convey a beverage additive by the thread of the auger through the opening 396 to dispense the beverage additive through the pod outlet 400 and into the mixing area 338. In some embodiments, the rotation may allow a volume of beverage additive conveyed by the auger to be predetermined for a given degree of rotation of the reservoir relative to the cap. Accordingly, in some embodiments in which a beverage machine includes a sensor to detect a rotational position of a pod, the machine may dispense a predetermined volume of beverage additive by rotating the reservoir by a predetermined degree of rotation, the predetermined degree of rotation based at least in part on angular orientation data obtained from the sensor and/or movement information from the pod drive wheel. Note that the reservoir 374 need not be limited in the number or amount of rotation of the reservoir 374 relative to the cap 376. For example, the cam follower 410 will disengage from a corresponding cam 388 to permit the reservoir 374 to rotate an unlimited amount relative to the cap 376, allowing dispensing of any desired amount of additive from the pod.

To close the pod after additive has been dispensed, e.g., from the state in FIG. 17E, the pod drive wheel may rotate the reservoir 374 in the reclose direction S. This causes the cap 376 to rotate with the reservoir 374 in the reclose direction S because the dispense notches 416 do not provide sufficient resistance to pod rotation in the reclose direction. This causes the spring pins 358 to disengage from the dispense notches 416 and the pod to rotate in the reclose direction S and translate downwardly into the pod receptacle. Translation downwardly further into the pod receptacle 330 when the pod is rotated in the close direction S may be limited or prevented by a receptacle floor 452 and/or by contact of the cap 376 with a portion of the pod receptacle. Accordingly, if the pod is rotated in the close direction S by the pod drive mechanism, the pod 336 may rotate without significant downward translation, allowing the spring pins 358 to engage with the reclose notches 424 as shown in FIG. 17F. The reclose notches 424, as described above, may prevent a further rotation of the cap 376 in the reclose direction S while the reservoir 374 may continue rotating in the close direction S relative to the cap. As the reservoir 374 rotates in the close direction S relative to the cap 376, the cam follower 410 may engage with the cam 388 to cause or guide a corresponding translation of the reservoir relative to the cap, e.g., movement of the cap toward the reservoir. The translation may move the sealing surface 408 of the reservoir towards the shoulder 406 of the cap to close the opening of the pod 336. With the pod in a closed state, the pod can be removed from the pod receptacle if desired. To do so, the pod drive wheel may rotate the pod in the dispense direction D so the spring pins 358 are disengaged from the reclose notches 424 and the pod (reservoir and cap) moves upwardly in the pod receptacle. This may cause the spring pins 358 to engage with a tapered portion of the cap 376, thus holding a distal end of the pod upwardly in the pod receptacle so a user can grasp the distal end. Since the spring pins 358 may contact the tapered portion of the cap, the spring pins 358 may present little or no resistance to removal of the pod.

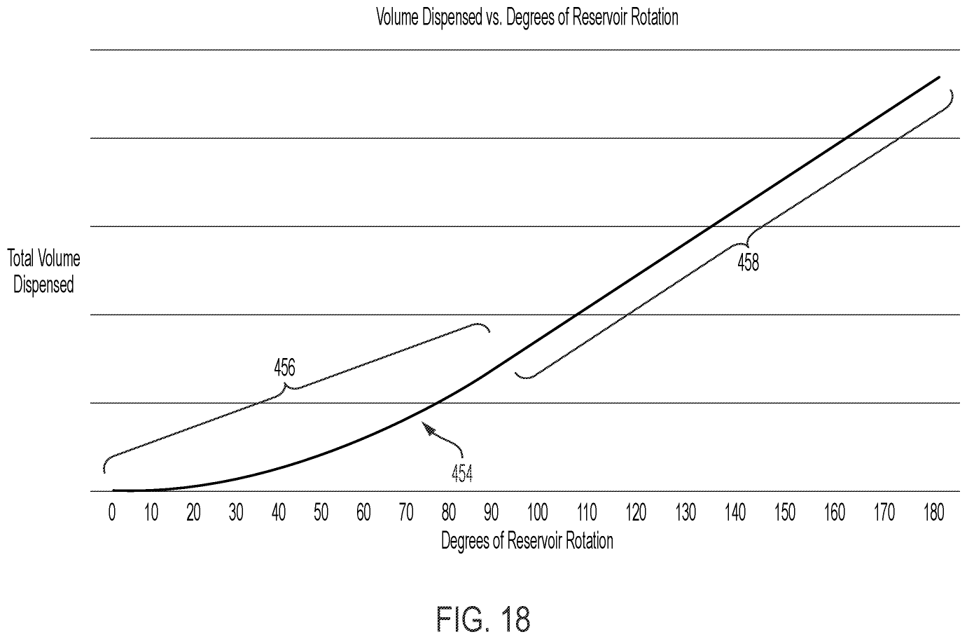

FIG. 18 depicts a chart 1500 showing a relationship between a total volume of powder dispensed and a degree of rotation of the reservoir according to some embodiments. It will be appreciated that the 0° rotation mark may correspond to a position of a pod within a pod receptacle wherein a pod retention mechanism of the pod receptacle is engaged with an engagement feature of the cap in order to allow a reservoir of the pod to rotate relative to the cap. For example, the pod may be in the position shown in FIG. 17D at the 0° rotation mark. As the pod begins to rotate, it will be appreciated that the opening 396 may be only partially opened as the sealing surface 408 is lifted away from the shoulder 406, and that the opening 396 may become progressively wider to allow a progressively larger volume of beverage additive to be dispensed with each successive degree of rotation. This opening phase may correspond to the non-linear region 456 of the curve 454, as the new volume dispensed with each degree may increase as the rotation progresses.

The opening 396 may reach a maximum width when the lip 412 of the cap engages with the foot 414 of the reservoir, allowing the reservoir to rotate substantially in-plane with the lip 412. When the opening 396 is at the maximum width, each degree of rotation may cause a consistent volume of beverage additive to be dispensed, as the width of the opening 396 is no longer changing with each degree. This steady-state phase may correspond to the linear region 458 of the curve 454, as the new volume dispensed with each degree of rotation may be constant as the rotation continues to progress, until the beverage additive becomes depleted.

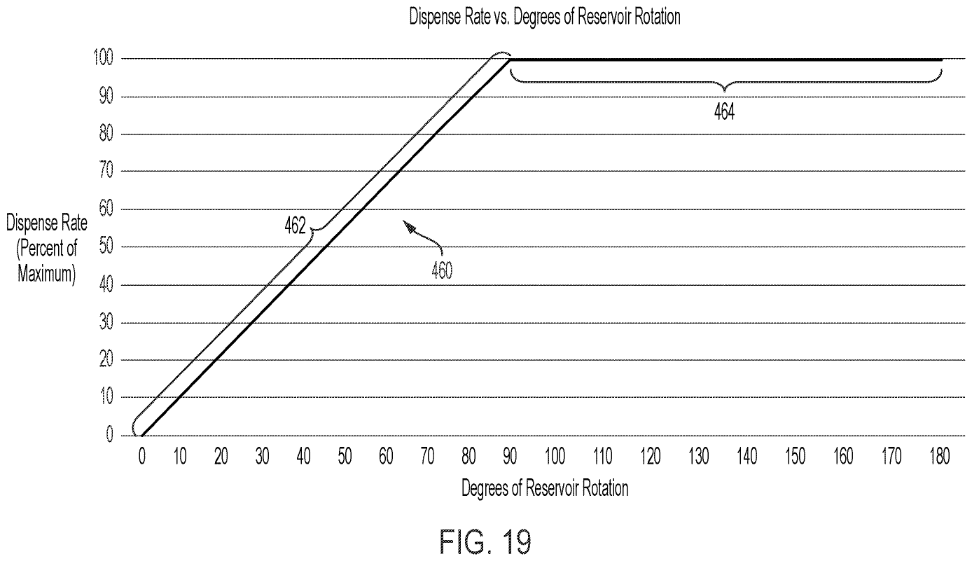

A similar concept is illustrated in FIG. 19, which depicts a dispense rate as a function of reservoir rotation. Without wishing to be bound by theory, a dispense rate may be a rate at which a beverage additive is dispensed for each degree of rotation. In other words, a dispense rate may be measured in terms of volume per unit of rotation, rather than a volume per unit of time. However, it will be appreciated that a dispense rate may additionally or alternatively be expressed as a volume per unit of time, provided a rate of rotation per unit time (e.g., rotations per minute) of the pod is known. During the opening phase, the dispense rate may be increasing with each degree of rotation as the opening 396 grows wider. This opening phase may correspond to the linear region 462 of the curve 460. When the opening 396 has reached a maximum width, the dispense rate may be constant. This steady-state phase may correspond to the flat region 464 of the curve 460. It will be appreciated that the dispense rate may be at a maximum when the opening is at a maximum width. Therefore, the chart of FIG. 19 depicts the dispense rate as being 100% of a maximum dispense rate when the opening is at a maximum width, according to some embodiments.

As will be appreciated by inspection of FIGS. 18-19, a predetermined degree of rotation of a reservoir relative to a cap (which may involve rotation of a cap relative to a pod holder or rotation of a reservoir relative to a pod holder) may result in a predictable or predetermined volume of beverage additive being dispensed. This may allow a controller of a beverage machine to calculate a predetermined degree of rotation by which to rotate a reservoir or cap in order to dispense a predetermined volume of a beverage additive from the pod. Additionally or alternatively, a controller may calculate a predetermined time of rotation for which to rotate the pod based on the predetermined degree of rotation desired and/or a rate of rotation which may be known or controlled by the controller. In some embodiments, the rate of rotation may be determined or controlled by controlling a power setting or rate of rotation of a pod drive wheel or a motor operatively coupled to the pod drive wheel. Accordingly, in some embodiments, a predetermined volume of beverage additive may be dispensed by rotating a pod portion for a predetermined period of time.

Although FIGS. 18-19 each depict a maximum width of an opening occurring at 90° of rotation, it will be appreciated that the maximum width may occur at any appropriate degree of rotation as the disclosure is not limited in this respect. The rotational degree at which the opening achieves a maximum width may be influenced by numerous parameters and/or dimensions chosen for a given design of a machine, a pod receptacle, and/or a pod according to the present disclosure.

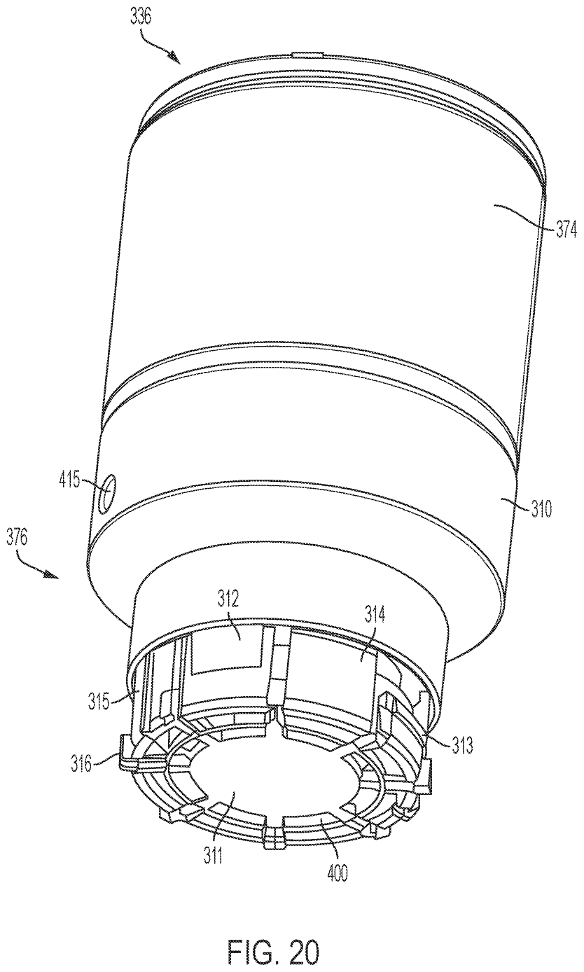

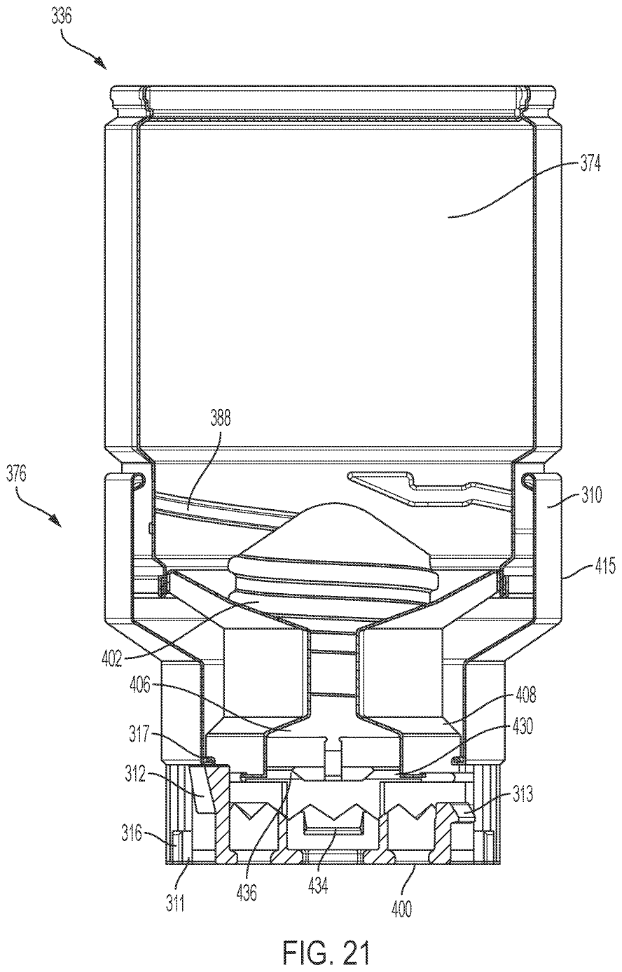

In some embodiments, a pod may include a cap with two or more portions that are movable relative to each other, e.g., to open and/or close a pod, enable the pod to dispense beverage additive and/or perform other functions. For example, FIGS. 20 and 21 show perspective and cross sectional views of a pod 336 that includes a cap 376 with a first portion 311 and a second portion 310 that are movable relative to each other. In some cases, the first portion 311 can be moveable linearly relative to the second portion 310, e.g., along a longitudinal axis of the pod 336, to pierce a membrane 430 at the opening 396 of the reservoir 374 that seals the internal volume of the reservoir 374 closed. The reservoir 374 can be configured as discussed in some of the pod embodiments discussed above, e.g., with a cylindrically shaped sidewall that extends along a longitudinal axis of the pod 336 from a closed distal end (e.g., closed by an end wall attached to the distal end of the sidewall) to the opening 396 at the proximal end. The sidewall of the reservoir 374 may taper to a smaller or larger diameter or other size in one or more places along the length of the pod. For example, the sidewall may have a cylindrical shape at a distal part and taper or step inwardly in size to a section that includes a cam 388 that engages with a cam follower 410 on the second portion 310 of the cap 376. The cam 388 and cam follower 410 may cooperate to move the second portion 310 of the cap toward and away from the reservoir 374 in response to rotation of the second portion 310 relative to the reservoir 374 as discussed above. Note that the relative locations of the cam 388 and cam follower 410 can be reversed, with the cam 388 on the second portion 310 and the cam follower 410 on the reservoir 374. The sidewall of the reservoir 374 may taper inwardly along a conical section to a passageway, e.g., having a cylindrical shape and in which an auger 402 may be received. In some cases, the sidewall may taper outwardly from the passageway, e.g., to define a sealing surface 408 before terminating at the opening 396. The opening 396 and thus the internal space of the reservoir 374 may be sealed closed by the membrane 430, e.g., which may be sealed to a rim or end surface of the reservoir 374. An auger 402, if provided, may be located in the sealed internal space of the reservoir 374. The membrane 430 may hold a shoulder 406 of the auger 402 against the sealing surface 408 of the reservoir 374, or the shoulder 406 may be spaced from the sealing surface 408 prior to piercing of the membrane 430.

In some cases, the first portion 311 can be movable relative to the second portion 310 and/or the reservoir 374 to pierce the membrane 430, e.g., to permit the beverage additive to be dispensed from the opening 396. For example, the first portion 311 can be movable linearly relative to the second portion 310 and the reservoir 374 to pierce the membrane 430. The first portion 311 can be received into a portion of the second portion 310 as the first portion 311 is moved from a closed position shown in FIGS. 20 and 21 in which the membrane 430 seals the opening 396 closed, to an open position in which the first portion pierces the membrane 430 and opens the opening 396 for additive dispensing. With respect to portions that pierce the membrane 430 and/or engage with an auger 402, the first portion 311 may be configured similarly to that described in relation to FIGS. 15A and 15B above, e.g., including crenellations 432 or other piercing members configured to pierce the membrane 430, which may be formed of a metal foil, polymer film, laminate of foil and polymer films, etc. The first portion 311 may include one or more rim portions 434 configured to engage with a ledge 436 of the auger 402, e.g., so that the auger 402 and the first portion 311 are longitudinally fixed or coupled so the first portion 311 and auger 402 move together longitudinally. Additionally, one or more anti-rotation tabs extending from the ledge 436 may cooperate with the crenellations, piercing members, or other portion of the first portion 311 to rotationally fix or couple the auger 402 and the first portion 311 so that the auger 402 can rotate with the first portion 311 and/or so that the auger 402.

In some embodiments, movement of the first portion 311 from the closed to the open position or other movement relative to the second portion 310 can be resisted by components of the first and/or second portions, e.g., to help prevent accidental or unwanted opening of the pod. For example, the first portion can include an interference tab 312 configured to contact the second portion 310 and resist linear movement of the first portion 311 relative to the second portion 310. The interference tab 312 can contact a part of the second portion 310, e.g., at the lower rim 317, preventing movement of the first portion 311 toward the second portion 310 and the reservoir 374. However, the interference tab 312 can be moved, e.g., flexed radially inwardly toward the opening 396, to clear the interference tab 312 from the rim 317 and allow the first portion 311 to be moved toward the second portion 310, e.g., into a space defined by the second portion 310. This movement can be caused by a user pushing the first and second portions 311, 310 toward each other after/during clearance movement of the interference tab 312. In some cases, the pod 336 can include two interference tabs 312, e.g., on opposed sides of the first portion 311, so a user can flex or more the interference tabs 312 using a thumb and forefinger to permit movement of the first portion 311 relative to the second portion 310. In some cases, the first portion 311 can be configured so the first portion 311 cannot be rotated relative to the second portion 310, e.g., after movement to the open position. For example, the first portion 311 can include a rib 315 or other feature that engages with a corresponding slot or groove of the second portion 310 to resist relative rotation of the first and second portions. This rotational engagement of the first and second portions can enable the second portion 310 to rotate the auger 402 via the first portion 311 once the first portion 311 has been engaged with the auger 402. The first portion 311 can also include a hook 313 configured to engage with the second portion and hold the first portion in the open position relative to the second portion. For example, one or more hooks 313 can engage with the rim 317 of the second portion 310 to hold the first portion 311 in the open position and prevent movement of the first portion 311 relative to the second portion 310. The range of movement of the first portion 311 relative to the second portion 310 in directions toward and away from the second portion 310 can be limited by one or more stops. For example, to prevent the first portion 311 from being disengaged from the second portion 310 while the first portion is in the closed position shown in FIGS. 20 and 21, the first portion 311 can include one or more stops 316, e.g., that engage with the rim 317 or other part of the second portion 310 and limit movement of the first portion 311 away from the second portion 310. One or more stops 316, e.g., that protrude radially from a lower part of the first portion 311, can limit movement of the first portion 311 toward the second portion 310, e.g., by contacting the rim 317 when the first portion 311 is in the open position.

With the first portion 311 in the open position relative to the second portion 310, the membrane 430 can be pierced and beverage additive dispensed. If an auger 402 is provided, the second portion 310 can be rotated relative to the reservoir 374, e.g., in an open direction, which causes the first portion 311 and auger 420 to rotate and disengage the shoulder 406 from the sealing surface 408. Continued rotation of the auger 402 can cause additive to be dispensed, e.g., as a thread on the auger 402 feeds additive to and through the opening 396 and holes 400 of the first portion 311. However, an auger 402 is not required, and piercing of the membrane 430 can open the opening 396 for dispensing additive. In some cases, a portion of the first portion 311 can engage with a part of the reservoir 374 at the opening 396 to close the opening 396 for dispensing. For example, when the first portion 311 is moved to the open position, the membrane 430 can be pierced and a part of the first portion 311 can contact the rim or edge of the reservoir 374 that defines the opening 396 so as to close the opening 396 to dispensing.

Thereafter, rotation of the second portion 310 and the first portion 311 relative to the reservoir in the open direction can move the first portion 311 away from the reservoir 374 and open the opening 396 to dispensing.

Rotation of the first and second portions relative to the reservoir can be done in any suitable way, including those discussed herein. For example, the second portion 310 can include one or more notches 315 configured to engage with a detent (e.g., a spring loaded pin) of a pod receptacle of a beverage machine so the second portion 310 can be held rotationally and/or longitudinally stationary relative to the pod receptacle. Rotation of the reservoir 374 relative to the second portion 310 can cause the cam 388 and cam follower 410 to move the cap 376 and reservoir 374 relative to each other to open and close the pod for dispensing. Note that the notches 315 are configured differently than those in the embodiments above, e.g., the notches 315 can be partial spherical depressions or recesses in the surface of the second portion 310. Thus, the notches 315 can be configured to help hold the cap 376 stationary in rotational and longitudinal directions, i.e., the notches 315 have both circumferential and longitudinal ridges. The notches 315 can be used during rotation of the cap 376 relative to the reservoir 374 in both open and close directions. Engagement of the notches 315 with a detent or other engagement feature of a pod receptacle can be achieved in any suitable way. For example, a user can place a pod in the receptacle and force the pod to move downwardly so the conically tapered surface of the second portion 310 engages with spring pins and forces the pins to retract until the pins are positioned along the (e.g., cylindrically shaped) sidewall of the second portion 310 where the notches 315 are formed. To align the pins with the notches 315, the user can rotate the pod until the pins and notches 315 are engaged. Alternately, a user can place a pod in a pod receptacle and close a lid of the pod receptacle. Closing of the lid can cause the lid to force the pod to move downwardly, engaging the spring pins with the tapered portion of the second portion 310, forcing the pins to retract and allowing the pod to move downwardly into the receptacle. A pod drive can be employed to rotate the pod (e.g., in the close direction) so the pins engage with the notches 315, if necessary. In some arrangements, a pod drive can rotate and move the pod longitudinally into the pod receptacle, causing the spring pins to retract and the pins to engage with the notches 315. In some arrangements, the spring pins can be retracted to permit the pod to be received without resistance by the spring pins. Of course, such detent-type engagement between the pod and the pod receptacle is not required. For example, the cap and/or reservoir of the pod can be clamped by a clamp of the pod receptacle (e.g., a collet-type clamp) to hold a part of the pod stationary, e.g., for rotation of another part of the pod relative to the stationary part.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1.-28. (canceled)

29. A pod for use in a beverage dispensing system, the pod comprising a reservoir and a cap, the reservoir configured to contain a beverage additive, wherein the cap and the reservoir are cooperatively engaged such that relative movement of the cap and the reservoir selectively closes or opens an opening of the pod to allow the beverage additive to be selectively dispensed from the pod, wherein:
the reservoir includes an outer surface configured to engage with a pod drive mechanism of the beverage dispensing system such that the reservoir is movable by the pod drive mechanism in at least one longitudinal or rotational direction,
the cap includes a first pair of notches disposed on opposing sides of the cap, and a second pair of notches disposed on opposing sides of the cap, each notch configured to selectively engage with one or more corresponding detents of the beverage dispensing system, each notch of the first pair comprising:
a first longitudinal ridge to resist a rotation of the cap in a first rotational direction during a rotation of the reservoir in the first rotational direction, and
each notch of the second pair comprising:
a second circumferential ridge to resist the movement of the cap in a second longitudinal direction during the longitudinal movement of the reservoir in the second longitudinal direction, and
a second longitudinal ridge to resist a rotation of the cap in a second rotational direction opposite the first rotational direction during a rotation of the reservoir in the second rotational direction.

30. The pod of claim 29, wherein the cap further comprises at least one visual indicium adjacent to at least one of the notches, the visual indicium configured to be detectable by a sensor of the beverage dispensing system.

31. The pod of claim 29, wherein the outer surface of the reservoir includes an orientation pattern configured to be detectable by a sensor of the beverage dispensing system such that the beverage dispensing system detects an orientation of the pod.

32. The pod of claim 29, wherein the outer surface of the reservoir includes a bar code, a quick response (QR) code, and/or a radio frequency identification (RFID) tag configured to be detectable by a sensor of the beverage dispensing system to provide data describing the contents of the pod to the beverage dispensing system.

33. (canceled)

34. The pod of claim 29, wherein a sealing surface of the reservoir cooperates with a shoulder of the cap to open and close the opening of the pod, and wherein the cap further comprises an auger including the shoulder, and wherein the auger is at least partially disposed within the opening and configured to convey the beverage additive from the reservoir through the opening.

35. (canceled)

36. The pod of claim 29, wherein each notch of the first pair includes a first circumferential ridge to resist a movement of the cap in a first longitudinal direction during a longitudinal movement of the reservoir in the first longitudinal direction, and
each notch of the second pair includes a third circumferential ridge to resist a movement of the cap in a second longitudinal direction opposite the first longitudinal direction during a longitudinal movement of the reservoir in the second longitudinal direction.

37. The pod of claim 29, wherein the cap and reservoir are engageable by a cam and cam follower configured to move the cap and reservoir toward and away from each other in response to rotation of the reservoir relative to the cap.

38.-40. (canceled)

41. A method of dispensing a beverage additive, the method comprising:
preventing a movement of a cap of a beverage additive pod by engaging a cap retention mechanism of a beverage machine with an engagement feature of the cap, the beverage additive pod configured to contain the beverage additive, and
moving a reservoir of the pod away from the cap to open an opening of the pod by actuating a pod drive mechanism of the additive dispensing system, the pod drive mechanism configured to engage with an outer surface of the reservoir to move the reservoir in at least one longitudinal direction and at least one rotational direction.

42. The method of claim 41, wherein engaging the cap retention mechanism with the engagement feature comprises engaging a spring pin of the beverage machine with a notch of the cap.

43. The method of claim 41, wherein engaging the cap retention mechanism with the engagement feature comprises engaging the cap retention mechanism with at least one of a circumferential ridge of a notch of the cap to prevent a movement of the cap in a longitudinal direction, and a longitudinal ridge of the notch of the cap to prevent a rotation of the cap.

44. (canceled)

45. The method of claim 41, wherein moving the reservoir comprises actuating a pod drive mechanism of the beverage dispensing system, the pod drive mechanism operatively engaged with the reservoir and configured to move the reservoir in at least one of a rotational direction and a longitudinal direction, and wherein actuating the pod drive mechanism comprises rotating a pod drive wheel about a drive axis disposed at an angle relative to a longitudinal axis of the pod.

46. (canceled)

47. The method of claim 45, wherein actuating the pod drive mechanism comprises frictionally engaging the pod drive wheel with an outer surface of the reservoir to move the reservoir in both the rotational direction and the longitudinal direction, and wherein frictionally engaging the pod drive wheel with the outer surface comprises frictionally engaging the pod drive wheel with a wear-resistant portion of the outer surface.

48.-49. (canceled)

50. The method of claim 41, further comprising moving the reservoir in at least one direction opposite the at least one longitudinal and/or rotational direction towards the cap to close the outlet.

51.-67. (canceled)

68. A pod for use in a beverage dispensing system, the pod comprising:
a reservoir having an internal volume configured to contain a beverage additive, the reservoir having a closed distal end portion and a proximal end portion having an opening to allow the beverage additive to be dispensed from the internal volume,
a membrane at the opening and sealing the internal volume closed; and
a cap having a portion movably engaged with the reservoir to pierce the membrane to permit the beverage additive to be dispensed from the opening.

69. The pod of claim 68, wherein the cap has first and second portions, the first portion being linearly movable relative to the second portion and the reservoir to pierce the membrane.

70. The pod of claim 69, wherein the first portion includes an interference tab configured to contact the second portion and resist linear movement of the first portion relative to the second portion, the interference tab being movable to permit linear movement of the first portion relative to the second portion from a closed position to an open position to pierce the membrane, and wherein the first portion includes a hook configured to engage with the second portion and hold the first portion in the open position relative to the second portion.

71.-72. (canceled)

73. The pod of claim 69, wherein the second portion is rotationally movable relative to the reservoir, and wherein the cap includes an auger positioned at the opening and within the internal space sealed by the membrane.

74. (canceled)

75. The pod of claim 73, wherein the first portion is movable relative to the second portion from a closed position to an open position to pierce the membrane, and wherein the first portion is configured to engage with the auger in the open position such that the auger moves rotationally with the second portion.

76. The pod of claim 75, wherein the first portion includes a hook configured to engage with the second portion and hold the first portion in the open position relative to the second portion, and wherein the first portion includes a rim portion configured to engage with a ledge of the auger.

77. The pod of claim 75, wherein the auger includes a shoulder configured to engage a sealing surface of the reservoir to resist the beverage additive from being dispensed through the opening, and wherein the second portion is engaged with the reservoir by a cam and cam follower configured to move the second portion toward and away from the reservoir in response to rotation of the second portion relative to the reservoir, and wherein rotation of the second portion relative to the reservoir to move the second portion away from the reservoir moves the shoulder out of contact with the sealing surface, and rotation of the second portion relative to the reservoir to move the second portion toward the reservoir moves the shoulder into contact with the sealing surface.

78. (canceled)
